(19) United States
(12) Patent Application Publication
(10) Pub. No.: US 2026/0128023 A1
(43) Pub. Date: May 7, 2026

(54) SOUND PRODUCTION METHOD FOR INTELLIGENT ERROR-CORRECTING GUITAR

(71) Applicant: Xueyun LIU, Wenzhou, Zhejiang (CN)

(72) Inventor: Xueyun LIU, Wenzhou, Zhejiang (CN)

(21) Appl. No.: 19/125,314

(22) PCT Filed: Jan. 15, 2024
(86) PCT No.: PCT/CN2024/072415

§ 371 Date: Sep. 23, 2025

(30) Foreign Application Priority Data
Nov. 17, 2022 (CN) 202211440336.0

(51) Int. Cl. G10H 1/00; G10H 1/34

(52) U.S. Cl. CPC G10H 1/0025; G10H 1/342; G10H 2210/105; G10H 2210/571; G10H 2220/165; G10H 2220/191; G10H 2220/265

(57) ABSTRACT

The present invention relates to the technical field of guitars. Disclosed are a sound production method for an intelligent error-correcting guitar. The intelligent error-correcting guitar comprises a control module, an audio playback module, a string-pressing sensor group and a string-plucking sensor group. When the intelligent error-correcting guitar operates, the control module is used for receiving a string-pressing combination signal acquired by the string-pressing sensor group and a string-string-plucking source signal acquired by the string-plucking sensor group; When receiving the signal from the string-pressing sensor group, the control module matches the signal with a preset string-pressing combination in the control module, and the control module simultaneously receives the string-string-plucking source signal from the string-plucking sensor group at the same time; And the control module specifies, according to the matched string-pressing combination and the string-string-plucking source signal, a corresponding audio file to be played by means of the audio playback module. By means of the present invention, error-correction sound production can be performed, thereby reducing the difficulty of playing and making the playing of a guitar easy; and the use is simple.

### TECHNICAL FIELD OF THE INVENTION

The present disclosure relates to the field of guitar technologies, and in particular, to a sound production method for an intelligent error correction guitar.

### BACKGROUND OF THE INVENTION

Guitar is a very popular musical instrument, and is popular with people. With more and more people learning guitar, being limited by factors such as economy and time, self-learning has gradually become a mainstream learning form. A conventional guitar is to first press a string with a left hand to form a chord, then pull the string with a right hand to vibrate the string, and then conduct the string to the body to be sound by the resonator. Beginners learn a traditional guitar, require first-month time learning and chord fingering and memorize a plurality of chords, have very high requirements for fingering and memory capabilities, often have a playing error before skilled mastering and chord fingering, and are difficult to correctly play a song, which results in most beginners giving up learning guitar due to inaccurate chord pressing when playing.

### SUMMARY OF THE PRESENT INVENTION

In view of this, the present invention provides a sound production method for an intelligent error correction guitar to solve the above technical problems.

In order to achieve the above objective, the present disclosure provides the following technical solutions:

A sound production method of the intelligent error correction guitar, the intelligent error correction guitar comprises a control module, an audio playback module, a string-pressing sensor group and a string-plucking sensor group. When the intelligent error correction guitar works, the control module is used for receiving the string-pressing combination signal collected by the string-pressing sensor group and the string-plucking source signal collected by the string-plucking sensor group, when the control module receives the signal from the string-pressing sensor group, it matches it with the preset string-pressing combination in the control module; the control module receives the string-string-plucking source signal of the string-plucking sensor group at the same time, and the control module determines the corresponding audio file for playback via the audio playback module by matching the input string-pressing combination with the predefined chord configuration and analyzing the chord information.

Further, an input module is further included, the input module is used for receiving one or more mode settings for inputting one or more modes and sending the mode setting to the control module, and the control module matches the mode setting while matching the string-pressing combination and the string-string-plucking source signal, and then plays the specified audio file through the audio playback module.

Further, the string-pressing combination preset in the control module includes a string-pressing sensor signal that must be triggered during chord playing and a string-pressing sensor signal that must not be triggered.

Further, the setting control module sends an audio playing instruction when receiving the touch string action sensed by the string-plucking sensor.

Further, the setting control module sends an audio playing instruction after receiving the touch string sensed by the string-plucking sensor and performing a string loosening action.

Further, the string-pressing sensor senses the string-pressing operation on the entire string.

Further, the string-pressing sensor senses the string of the specific fret position of the string.

Further, the intelligent error correction guitar further includes a display module, configured to display a current state of the guitar.

Further, the control module, the input module and the audio playback module of the intelligent error correction guitar are all arranged on the guitar body.

Further, the audio playback module has six audio playback channels in one-to-one correspondence with the strings, and the control module respectively sends the designated audio files to the corresponding audio playback channels for playing according to the specific strings sensed by the received string-plucking sensors.

Further, the audio playback module has a audio playback channel.

Further, the control module of the intelligent error correction guitar is paired with the intelligent terminal through wired or wireless data transmission, and the intelligent terminal processes the received string sent by the control module and plays the corresponding audio file stored in the intelligent terminal.

### BENEFICIAL EFFECTS OF THE INVENTION

It can be seen from the above technical solution that the present invention has the following advantages: in the playing process, the chord with the wrong pressing can be defaulted as the chord with the correct pressing, and the audio playback module is used to play the correct chord to record the audio, so that the beginner can smoothly play the song under the condition of unskilled mastering and chord, so that the beginner does not give up learning due to the fact that the song cannot be played, and the learning interest is stimulated; The program may be set to switch to a mode of improving the difficulty of chord pressing, continue playing, and cancel the program auxiliary function to reach the traditional guitar playing level after the chord skill is completely mastered; that is, the fun of guitar playing is kept, the playing difficulty is reduced, and certain help is provided for the learning guitar fingering.

In addition to the objects, features and advantages described above, the present invention has other objects, features and advantages. The present invention will be further described in detail below with reference to the drawings.

### BRIEF DESCRIPTION OF THE DRAWINGS

In order to more clearly illustrate the embodiments of the present disclosure or the technical solutions in the prior art, the drawings required in the description of the embodiments or the prior art will be briefly described below, and obviously, the drawings in the following description are merely some embodiments of the present disclosure, and for those of ordinary skill in the art, other drawings may be obtained according to these drawings without creative efforts.

FIG. 1A to FIG. 1E form a simplified version computer program flow chart of the present invention.

FIG. 2A to FIG. 1E form a computer version program flow chart of the standard version of the present invention.

FIG. 3A to FIG. 3K form a flowchart of a guitar program according to the present invention.

FIG. 4 is a first schematic structural diagram of an intelligent error correction guitar using a touch switch to sense strings according to the present invention.

FIG. 5 is a second schematic structural diagram of an intelligent error correction guitar using a touch switch to sense strings according to the present invention.

FIG. 6 is a third schematic structural diagram of an intelligent error correction guitar using a touch switch to sense strings according to the present invention.

FIG. 7 is a fourth schematic structural diagram of an intelligent error correction guitar using touch switch sensing strings according to the present invention.

FIG. 8 is a schematic structural diagram of an intelligent error correction guitar using a key switch to sense upper strings according to the present invention.

FIG. 9 is a first schematic structural diagram of an intelligent error correction guitar using a photosensitive probe to sense strings in the present invention.

FIG. 10 is a second schematic structural diagram of an intelligent error correction guitar using a photosensitive probe to sense strings in the present invention.

FIG. 11 is a first schematic structural diagram of an intelligent error correction guitar using an auxiliary device according to the present invention.

FIG. 12 is a schematic diagram of a split structure of the auxiliary device body in FIG. 11 of the present invention.

FIG. 13 is a schematic diagram of a control principle of an intelligent error correction guitar according to the present invention.

In the drawings: a guitar case 1, an iron sheet 11, an upper string 2, a lower string 3, an auxiliary device 4, a string-pressing sensor group 41, a string-plucking sensor group 42, a wire 43, an audio playback module 44, and an input module 45

### DETAILED DESCRIPTION OF THE EMBODIMENTS

The technical solutions in the embodiments of the present disclosure will be clearly and completely described below with reference to the accompanying drawings in the embodiments of the present disclosure. Obviously, the described embodiments are only a part of the embodiments of the present invention, not all embodiments. All other embodiments obtained by a person of ordinary skill in the art based on the embodiments of the present invention without creative efforts shall fall within the protection scope of the present invention.

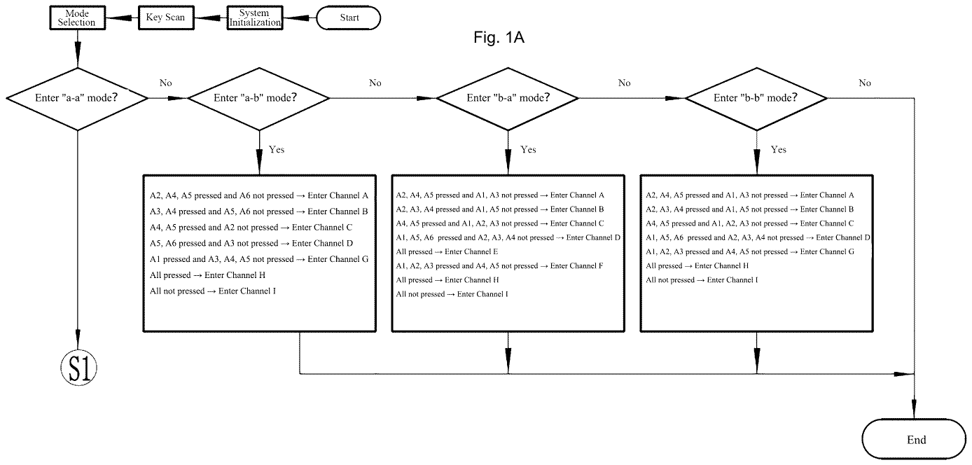

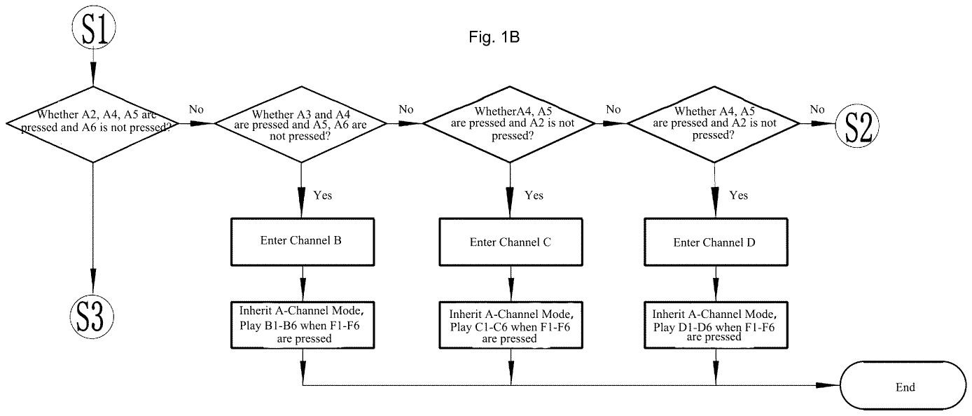

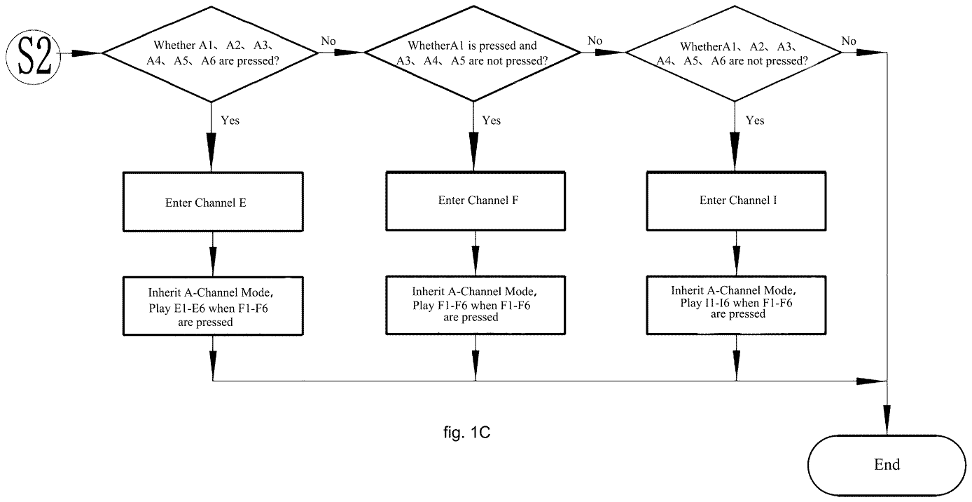

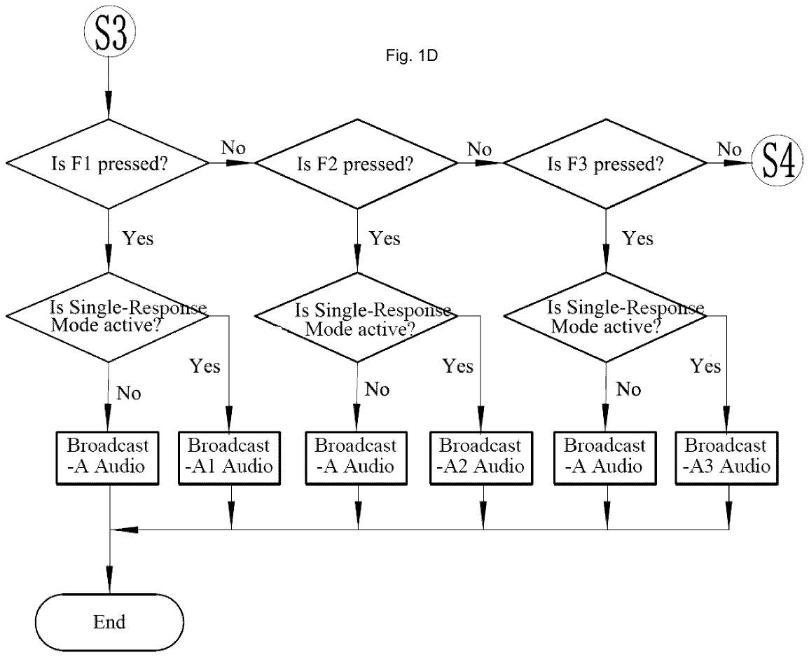

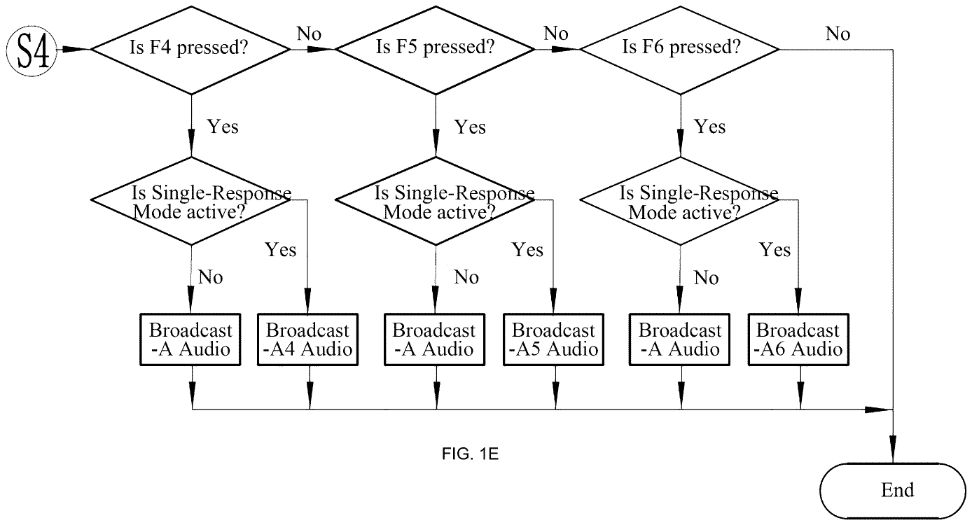

This application is further described with reference to FIG. 1 to FIG. 13.

As shown in FIG. 1A to FIG. 3K and FIG. 13, A sound production method of the intelligent error correction guitar, the intelligent error correction guitar comprises a control module, an audio playback module, a string-pressing sensor group and a string-plucking sensor group. When the intelligent error correction guitar works, the control module is used for receiving the string-pressing combination signal collected by the string-pressing sensor group and the string-plucking source signal collected by the string-plucking sensor group, when the control module receives the signal from the string-pressing sensor group, it matches it with the preset string-pressing combination in the control module; the control module receives the string-string-plucking source signal of the string-plucking sensor group at the same time, and the control module determines the corresponding audio file for playback via the audio playback module by matching the input string-pressing combination with the predefined chord configuration and analyzing the chord information.

In this embodiment of this application, the audio playback module includes an audio storage module and a speaker, the control module is a single-chip microcomputer, and after the string is triggered, the sensor sends a signal to be optically coupled and isolated and then sent to the single-chip microcomputer, so that the control module detects the string touch signal through the sensor group, controls the audio playback module to broadcast the audio file, and increases the audio signal amplification when the voice is output.

In an embodiment of the present application, the sensor used in the string-pressing sensor group is one or a combination of a capacitive touch switch, a light sensing probe, a button switch, an inductive touch switch, a photoelectric touch switch or a vibration switch type sensor, and a sensor used in the string-plucking sensor group is used in one or a combination of a capacitive touch switch, a light sensing probe, an inductive touch switch, a photoelectric touch switch, or a vibration switch type sensor.

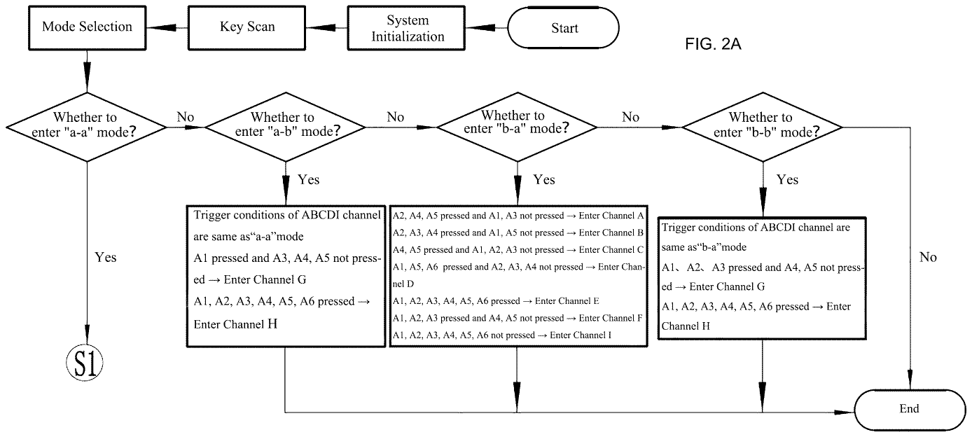

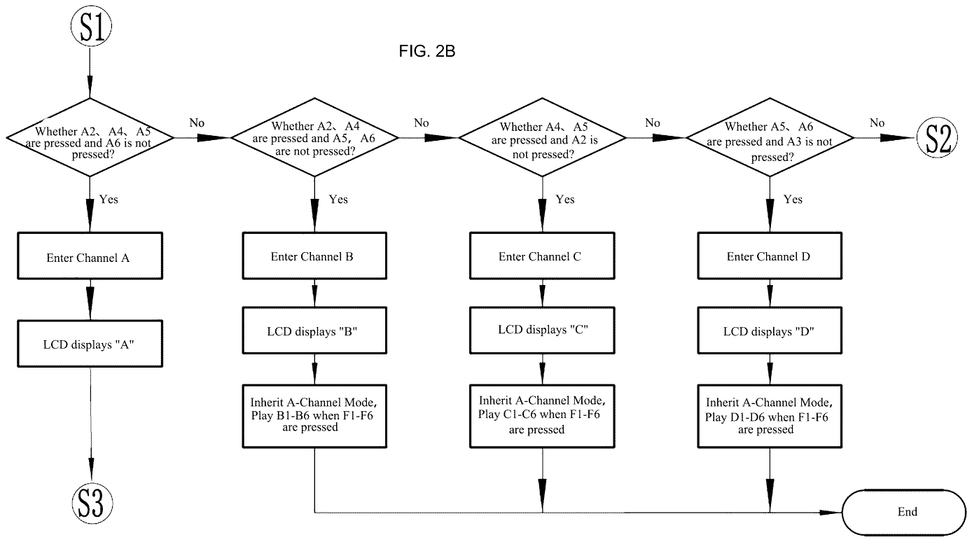

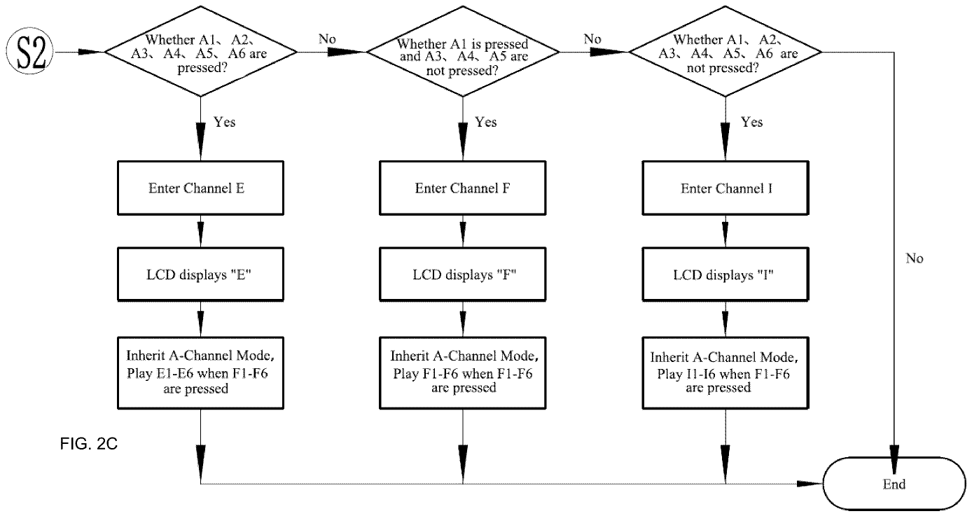

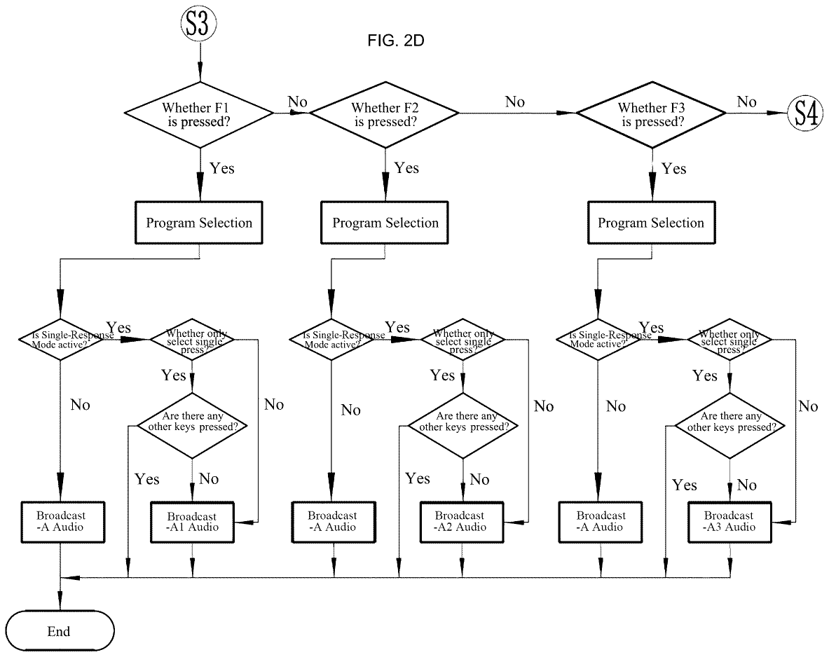

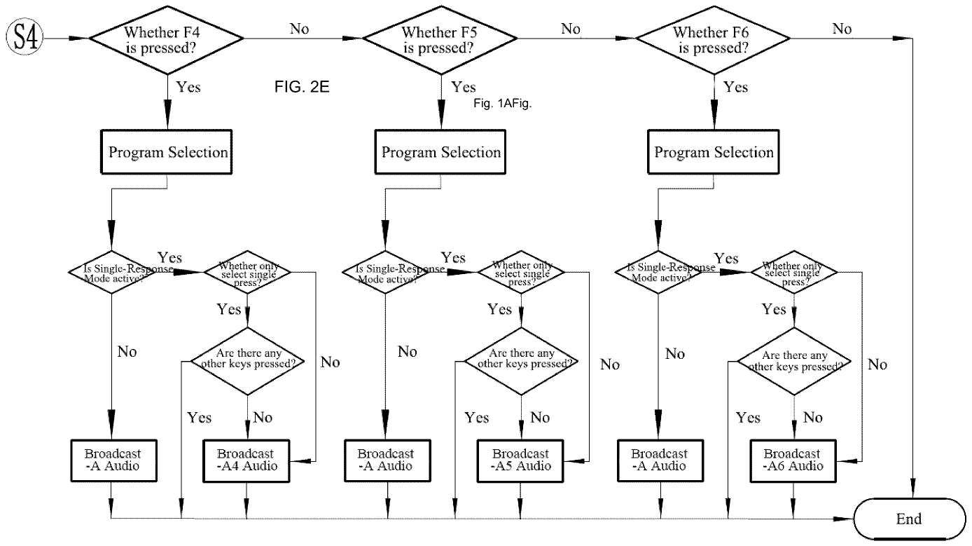

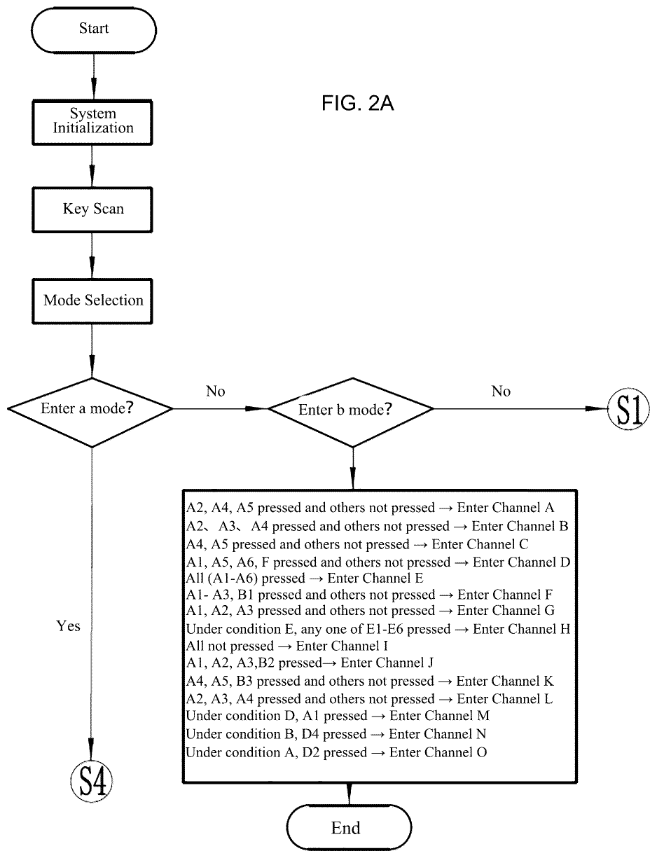

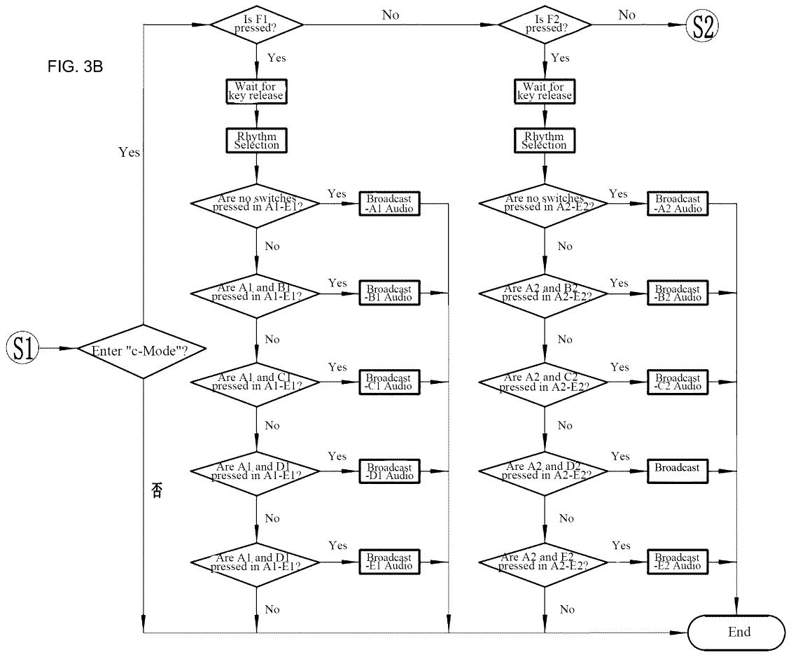

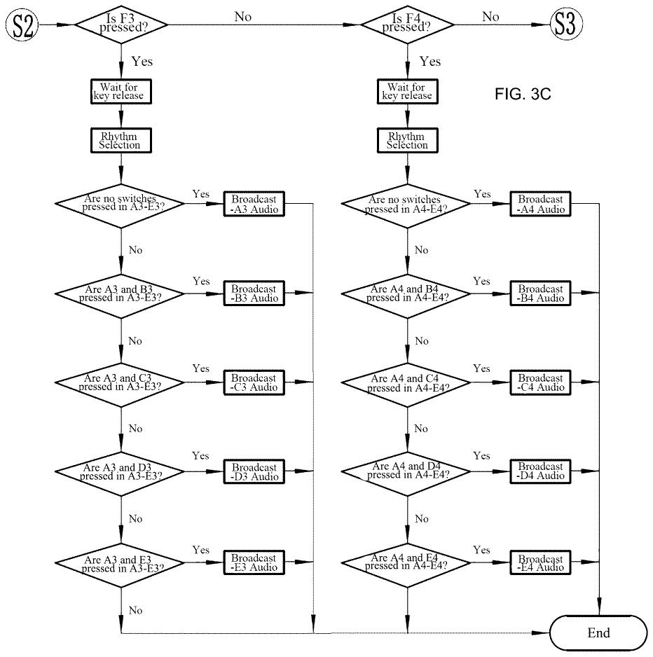

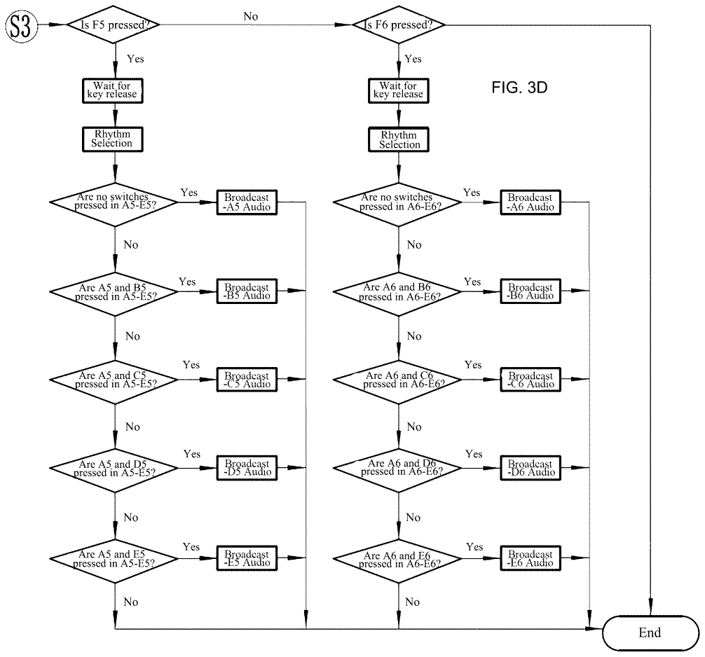

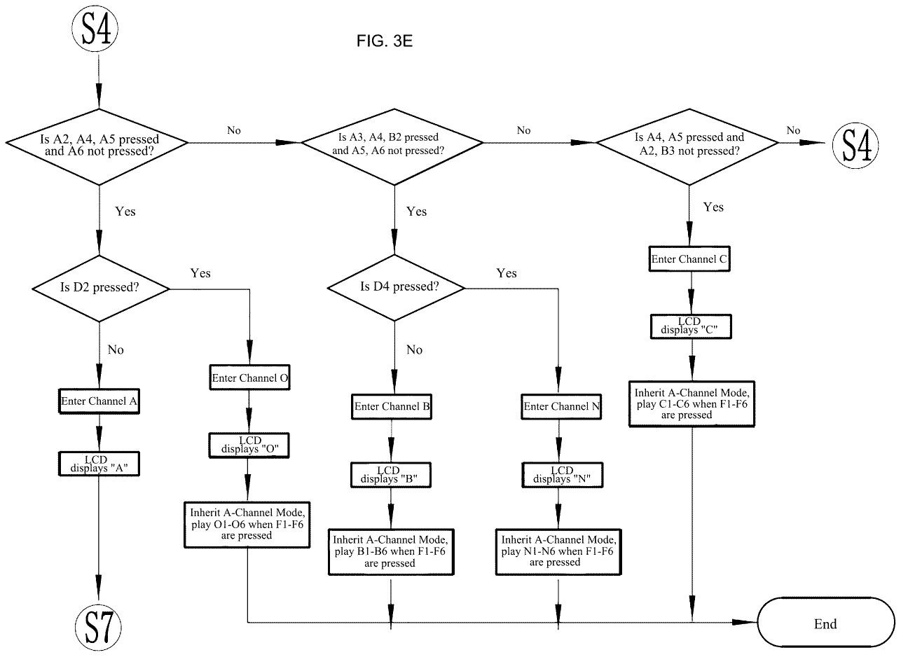

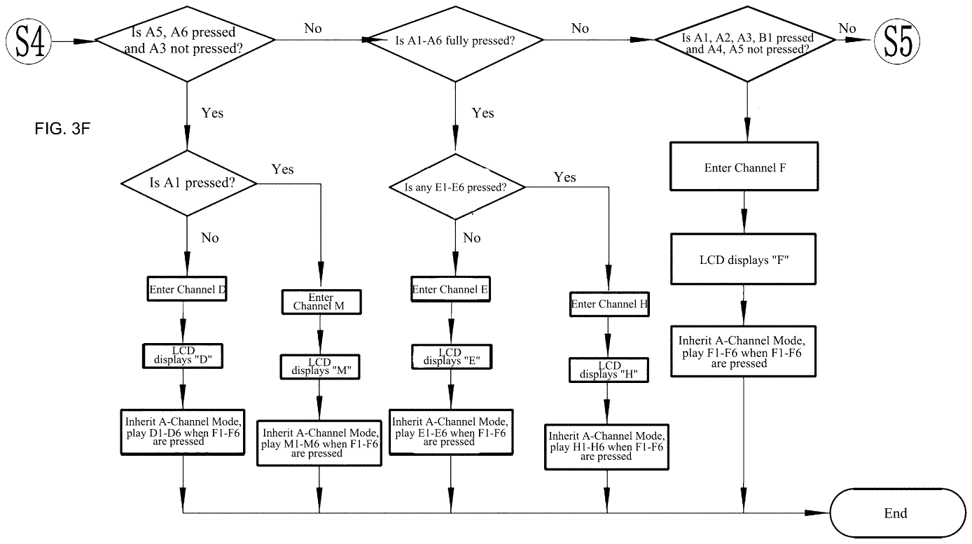

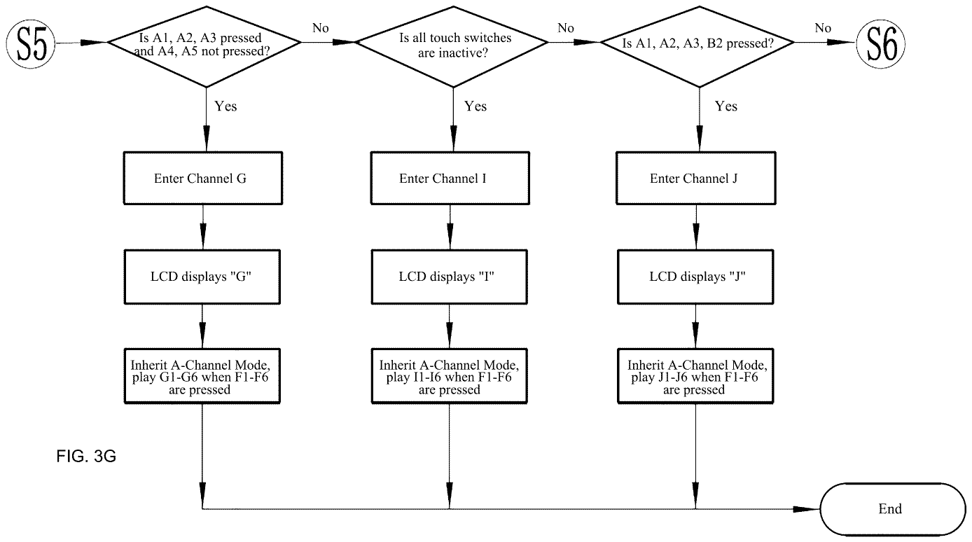

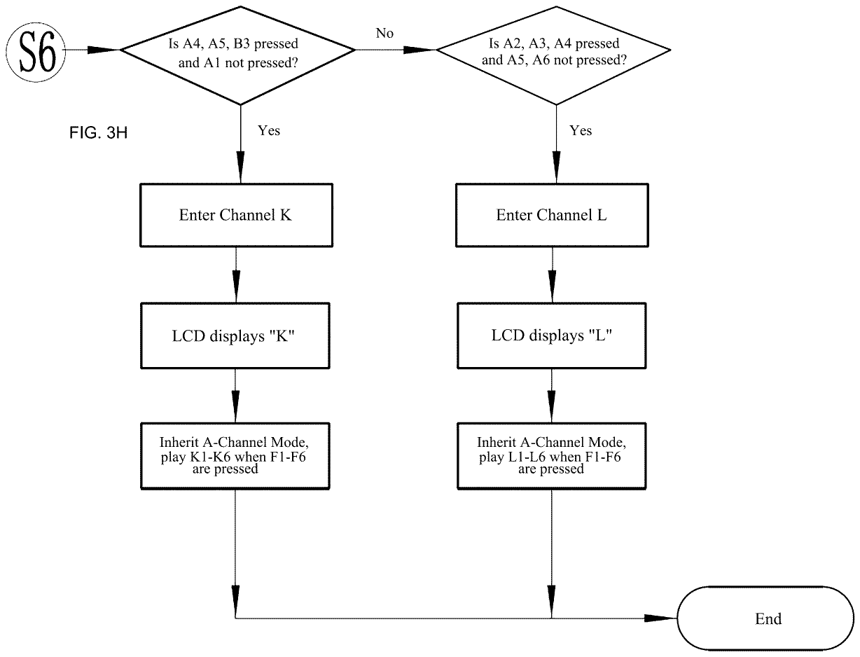

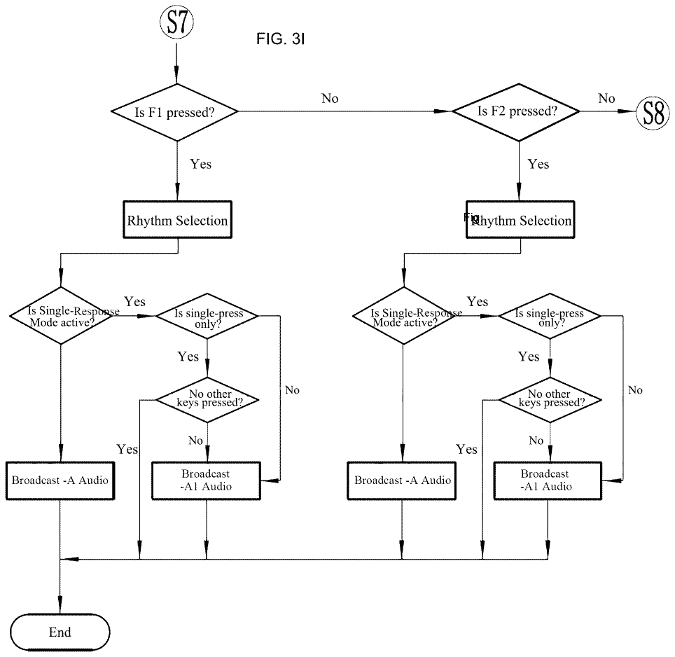

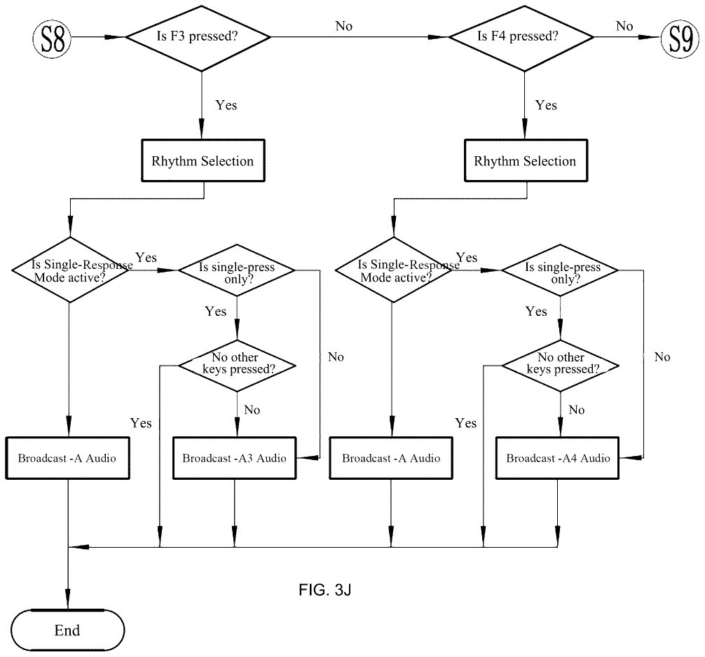

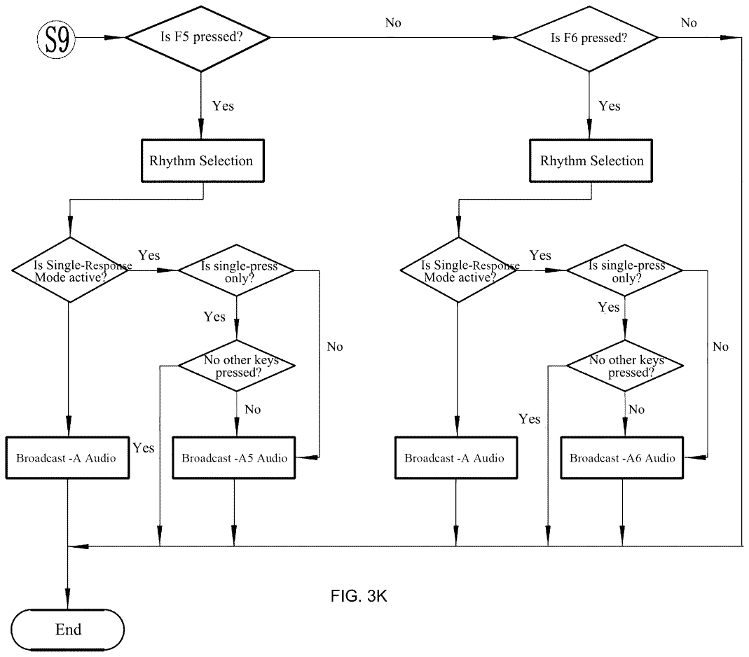

As shown in FIGS. 2A-3K, in an embodiment of the present application, the present application further includes an input module, the input module is configured to input one or more modes into one or more modes and send the mode setting to the control module, and the control module matches the mode setting while matching the string-pressing combination and the string-string-plucking source signal, and then plays the specified audio file through the audio playback module.

During specific operation, one or more different string-pressing matching modes are set manually, then string playing is performed, in the playing process, the control module performs the string-pressing combination and the string-string-plucking source signal preset in the matching control module in the set mode, and then the control module specifies the corresponding audio file to be played through the audio playback module according to the matched string-pressing combination and the string-string-plucking source signal; In the playing process, the control module firstly matches a preset string-pressing combination and a string-string-plucking source signal in the string playing information matching control module according to the string playing information received by the control module, the control module matches the set corresponding mode according to the matched string-pressing combination and the string-string-plucking source signal, and after the mode matching is completed, the corresponding audio file is designated to be played through the audio playback module.

In order to achieve different degrees of error correction pronunciation, the preset string-pressing combination in the control module includes a string-pressing sensor signal that must be triggered during chord playing and a string-pressing sensor signal that must not be triggered. When there are more signals that must not be triggered and included in the preset string-pressing combination, the greater the playing difficulty, the smaller the playing difficulty when the preset string-pressing sensor signals included in the preset string-pressing combination are less.

As shown in FIGS. 2A-3K, in an embodiment of this application, before the guitar is played, an input module may be further used to perform rhythm selection. After rhythm selection, during playing, when playing, the control module matches the corresponding audio file according to the selected rhythm rule when the string playing combination matches the corresponding string-pressing combination and the string-string-plucking source signal set in the string playing combination matching control module, and then plays the specified audio file through the audio playback module, wherein the playing audio files of the same chord tone with different rhythms are pre-recorded and stored in the audio playback module, the rhythm is different, and the strength of the audio file is different.

Specifically, in this embodiment of this application, five rhythm selections are set, and when the rhythm is selected as 1, the intensities of all the audio files in the string-plucking process are all normal; When the string is selected to be 2, the audio file played in the string-plucking process is strong, the weak loop is alternated, that is, the string is plucked for the first time, the control module specifies audio file playing with a strong rhythm under the corresponding string combination, the string is plucked for the second time, the control module specifies the audio file playing corresponding to the rhythm under the string combination, the string is toggled for the third time, the control module specifies the audio file playing corresponding to the rhythm under the string combination, the string is plucked for the fourth time, and the control module specifies that the audio file corresponding to the rhythm under the string combination is played; When the selection is 3, the audio file played in the string-plucking process is strong, weak, and sub-strong loop alternating; when the selection is 4, the audio file played in the string-plucking process is weak, strong, weak, and weak loop alternating; and when the selection is 5, the audio file played in the string-plucking process is strong, weak, weak, sub-strong, and weak and weak loop alternating.

As shown in FIGS. 2A-3K, in this embodiment of this application, whether the corresponding audio file can only be played in a single-press mode may be selected by using the input module. When the selection is yes, the setting control module sends an audio playing instruction when receiving the action that the string-plucking sensor senses the contact and the string is loosened and no other strings are plucked, and if not, the setting control module sends an audio playing instruction when receiving the touch action sensed by the string-plucking sensor.

In this embodiment of this application, the string-pressing sensor senses the string pressing operation on the entire string.

Specifically, the string-pressing sensor group includes six sensors for capturing information of pressing a whole string by a finger; and the string-plucking sensor group includes six sensors for capturing information of pulling the string by a finger.

In an embodiment of the present disclosure, the string-pressing sensor group senses a string of a specific fret position of the string.

Specifically, the string-pressing sensor group includes 30 sensors, configured to capture string information of a finger-to-string specific fret position; and the string-plucking sensor group includes six sensors, configured to capture information about a finger to toggle the string.

As shown in FIGS. 2A-3K, the intelligent error correction guitar further includes a display module for displaying the current state of the guitar.

Specifically, the current state includes a plurality of selected results, such as mode setting, rhythm selection, and indication of whether playing is correct.

In the embodiment of the present application, when the combination of the string-pressing combination and the string-string-plucking source signal cannot be matched with the set combination in the control module, the intelligent error correction guitar does not sound or display an error prompt or sends an error prompt audio.

In an embodiment of the present application, the control module, the input module, the display module and the audio playback module of the intelligent error correction guitar are all disposed on the guitar body, wherein the display module is a liquid crystal screen controlled to be connected to the control module, and may also be an indicator light or another indication apparatus. The working principle is that the intelligent error correction guitar is a circuit chip of a sound input control module that firstly plays a guitar, and places the circuit chip on the guitar. Then, several sensors are installed on the guitar, when a person is playing, the string is pressed by the left hand to trigger one or more sensors, the string-pressing sensor group generates a signal to identify the corresponding chord played currently by the circuit chip, then the string instrument trigger sensor is triggered by the right hand, the string-pressing sensor group generates a signal to be recognized by the circuit chip, the control module combines the string-pressing combination and the string-string-plucking source signal to calculate the corresponding chord note of the corresponding chord to be played, and then the circuit chip releases the specified audio from the player.

The whole circuit of the control module includes: a single-chip microcomputer minimum system circuit, a key circuit, a touch circuit, a liquid crystal display circuit, a voice broadcast circuit, an audio amplification circuit, and a power supply circuit.

Specifically, the control module, the audio playback module, the string-pressing sensor group, the string-plucking sensor group, the input module, the display module and the audio playback module are all arranged on a body of the guitar or the control module, the audio playback module, the string-pressing sensor group, the string-plucking sensor group, the input module, the display module and the audio playback module are integrated to form a guitar playing auxiliary device, during use, the guitar playing auxiliary device is installed on the corresponding guitar, the string of the guitar is divided into two sections, the guitar playing auxiliary device can also be integrated with strings of two sections, In order to avoid mutual influence when playing with strings-pressing and strings-plucking, and when the guitar playing auxiliary device is used, the playing auxiliary device with the strings and the strings on any guitar are replaced for use, so that the universality is good, and the input module can be preferably a key module.

When the control module, the input module, the display module and the audio playback module are all arranged on the guitar body, in one embodiment of the present application, the audio playback module has six audio playback channels in one-to-one correspondence with the strings, and the control module separately sends the specified audio files to the corresponding audio playback channels for playing according to the specific strings sensed by the received string-plucking sensors, that is, when the string-pressing signals do not change, the corresponding strings are plucked, the corresponding audio matched by the combination of the string-pressing signal and the string-string-plucking source signal is played through the playback source corresponding to the string. When multiple playback sources are played simultaneously, it is the sound of sweeping the string.

When the control module, the input module, the display module, and the audio playback module are all disposed on the guitar body, in another embodiment of the present application, the audio playback module has a audio playback channel

Specifically, the input module can be used to select whether the audio file playback is in single-response/single-note mode, when plucking the strings, thereby choosing between the string-plucking mode or the string-strumming mode. when the intelligent error correction guitar is in the string-plucking mode, the control module sends the specified audio file to the audio playback channel for playing according to the received signal combination of the wire plucking sensor; when the single string is plucked, the corresponding audio matched with the string signal and the string-string-plucking source signal is combined to be played through the audio playback channel, and when the intelligent error correction guitar is in the string sweeping mode, when plucking multiple strings, the audio file containing the joint recording of the corresponding audio matched with the string-pressing signal and the plurality of string-string-plucking source signals in a one-to-one mode is designated to be played through the audio playback channel, so that the condition of incomplete audio is avoided.

In a specific embodiment of this application, the audio playback channel is an audio player.

In another embodiment of this application, the control module of the intelligent error correction guitar is paired with the intelligent terminal through wired or wireless data transmission, and the intelligent terminal processes the received string playing information sent by the control module and plays a corresponding audio file stored in the intelligent terminal. In an actual use process, the control module disposed on the intelligent error correction guitar has the functions of converting the string sensor signal and sending the string playing combination information to the intelligent terminal, matching the received string playing combination information with the string combination information preset in the intelligent terminal by using software and hardware of the intelligent terminal, and playing the specified corresponding audio file according to the matching result; Or, the control module disposed on the intelligent error correction guitar has the function that the string sensor signal can be converted, the received string playing combination information is matched with the string combination information preset in the control module, the matching result is sent to the intelligent terminal, and the intelligent terminal calculates the received string matching result and plays the corresponding audio file stored in the intelligent terminal; Some functions of the control module of the intelligent error correction guitar can be replaced by using the intelligent terminal, and the function is complete by hardware and software of the intelligent terminal, so that the weight of the intelligent error correction guitar is reduced, the cost is reduced, or the volume of the playing auxiliary device is reduced, the weight is reduced, and the cost is reduced, wherein the input module, the display module and the audio playback module are replaced by hardware of the intelligent terminal, and the control module is used.

Preferably, when the control module is paired with the intelligent terminal through wired data transmission, the control module is connected with the intelligent terminal by using the data line, and the control module uses the Bluetooth connection when the wireless data transmission is paired with the intelligent terminal for use.

The entire circuit of the control module includes a single-chip microcomputer minimum system circuit and a power supply circuit.

In order to specifically describe the sound production method of the intelligent error correction guitar, a specific program flow chart is now used for description as follows:

When the string combinations entering the same chord are the same but require different chord compositions, or when the same string combination can enter different chords, the corresponding chord compositions can be selected by selecting different modes first, When entering different chords or composing different chords of the same chord, the required string combinations are also different. The strings can be played first, and then the string combinations can be used to match the audio in the corresponding mode, and in the preferred specific programs in FIG. 1, FIG. 2 and FIG. 3, the guitar sound production is realized in a first selection mode and then playing.

Referring to FIG. 1A to FIG. 1E and FIG. 2A to FIG. 2E, the control module matches the working method of the audio file according to the playing information (taking the computer version program as an example, and the audio playback module has only one audio playback channel, where the string code in the program is described: A1, A2, A3, A4, A5, and A6 respectively represent upper 1string, upper 2 string, upper 3 string, upper 4 string, upper 5 string, upper 6 string, F1, F2, F3, F4, F5, and F6 respectively represent string channel descriptions in the lower 1 string, the lower 2 string, the lower 3 string, the lower 4 string, the lower 5 string, the lower 6 string, and the program: The I channel represents an Open chord, the A channel represents a C chord, the B channel represents an AM chord, the C channel represents an EM chord, the D channel represents a G chord, the E channel represents an F chord, the F channel represents a DM chord, the G channel represents a D chord, and the H channel represents a BM chord; Audio play description in the procedure: -A represents a C chord strum, and -B represents an AM chord strum. and so on ; A1, A2, A3, A4, A5, A6 represent C chord 1 chord, C chord 2 chord, C chord 3 chord, C chord 4 chord, C chord 5 chord, C chord 6 chord, B1, B2, B3, B4, B5, B6 respectively represent AM chord 1 chord, AM chord 2 chord, AM chord 3 chord, AM chord 4 chord, AM chord 5 chord, AM chord 6 chord. and so on):

Selecting an a-a mode or an a-b mode or a b-a mode or a b-B mode through an input module;

When the entering a-a mode is selected, the control module determines whether the pressing string combination is A2, A4, A5, and A6 is not pressed, or is A3, A4 is pressed and A5 and A6 are not pressed, or if A5, A5 are pressed and A2 is not pressed, or whether A5 and A6 are pressed and A3, A4, A5 and A 6 are pressed, If A1 is pressed and A3, A4 and A5 are not pressed, or all strings are not pressed, A channel or a B channel or a C channel or a D channel or an E channel or an E channel or an I channel are entered according to conditions met by the pressing string combination determined by the control module, and the control module matches the corresponding audio file by determining that the string-plucking source signal is F1 or/and F2 or/and F3 or/and F4 or/and F5 or/and F6, and then the audio file is played in a set form;

Specifically,

When entering the a-a mode, the control module determines that the string combination is pressed:

When A2, A4, A5 are pressed, and A6 is not pressed, the A channel is entered, at this moment:

Broadcast A1 audio when the string-plucking source signal is F1 and a single-response mode; when the string-plucking source signal is F1 and is a non-single-response mode, broadcast -A audio;

Broadcast A2 audio when the string-plucking source signal is F2 and a single-response mode; when the string-plucking source signal is F2 and is a non-single-response mode, broadcast -A audio;

Broadcasting the A3 audio when the string-plucking source signal is F3 and in a single-response mode; broadcasting -A audio when the string-plucking source signal is F3 and is a non-single-response mode;

Broadcasting the A4 audio when the string-plucking source signal is F4 and in a single-response mode; broadcasting -A audio when the string-plucking source signal is F4 and is a non-single-response mode;

When the string-plucking source signal is F5, and is in a single-response mode, the A5 audio is broadcast; when the string-plucking source signal is F5, and is a non-single-response mode, the -A audio is broadcast;

When the string-plucking source signal is F6, and is a single-response mode, the A6 audio is broadcast; and when the string-plucking source signal is F3, and is a non-single-response mode, the -A audio is broadcast.

When A3 and A4 are pressed and A5 and A6 are not pressed, B channels are entered, at this time:

Broadcasting B1 audio when the string-plucking source signal is F1 and in a single-response mode; broadcasting -B audio when the string-plucking source signal is F1 and is a non-single-response mode;

Broadcast a B2 audio when the string-plucking source signal is F2 and a single-response mode; when the string-plucking source signal is F2 and is a non-single-response mode, broadcast -B audio; and

Broadcasting B3 audio when the string-plucking source signal is F3 and in a single-response mode; broadcasting -B audio when the string-plucking source signal is F3 and is a non-single-response mode;

Broadcasting B4 audio when the string-plucking source signal is F4 and in a single-response mode; broadcasting -B audio when the string-plucking source signal is F4 and is a non-single-response mode;

Broadcasting the B5 audio in a single-response mode when the string-plucking source signal is F5, and broadcasting the B5 audio in a single-response mode; and broadcasting the -B audio in a non-single-response mode; and

When the string-plucking source signal is F6, and is a single-response mode, the B6 audio is broadcast; and when the string-plucking source signal is F3, and is a non-single-response mode, the -B audio is broadcast.

When A4 and A5 are pressed and A2 is not pressed, the channel enters the C channel, and at this time:

Broadcasting the C1 audio when the string-plucking source signal is F1, and broadcasting the C1 audio in a single-response mode; broadcasting -C audio when the string-plucking source signal is F1 and is a non-single-response mode;

Broadcasting the C2 audio when the string-plucking source signal is F2, and broadcasting the C2 audio in a single-response mode; broadcasting -C audio when the string-plucking source signal is F2 and is a non-single-response mode;

Broadcasting C3 audio when the string-plucking source signal is F3 and in a single-response mode; broadcasting -C audio when the string-plucking source signal is F3 and is a non-single-response mode;

Broadcasting C4 audio when the string-plucking source signal is F4 and in a single-response mode; broadcasting -C audio when the string-plucking source signal is F4 and is a non-single-response mode;

Broadcasting C5 audio when the string-plucking source signal is F5, and broadcasting C5 audio in a single-sound mode; broadcasting -C audio when the string-plucking source signal is F5 and is in a non-single-response mode;

When the string-plucking source signal is F6, and is in a single-response mode, the C6 audio is broadcast; and when the string-plucking source signal is F3, and is a non-single-response mode, the -C audio is broadcast.

When A5 and A6 are pressed and A3 is not pressed, enter the D channel, at this time:

Broadcasting the audio of D1 when the string-plucking source signal is F1 and in a single-response mode; broadcasting -D audio when the string-plucking source signal is F1 and is a non-single-response mode;

Broadcasting D2 audio when the string-plucking source signal is F2 and in a single-response mode; broadcasting -D audio when the string-plucking source signal is F2 and is a non-single-response mode;

Broadcasting D3 audio when the string-plucking source signal is F3 and in a single-response mode; broadcasting -D audio when the string-plucking source signal is F3 and is a non-single-response mode;

Broadcasting D4 audio when the string-plucking source signal is F4 and in a single-response mode; broadcasting -D audio when the string-plucking source signal is F4 and is a non-single-response mode;

Broadcasting D5 audio when the string-plucking source signal is F5 and in a single-response mode; broadcasting -D audio when the string-plucking source signal is F5 and is a non-single-response mode;

When the string-plucking source signal is F6, and is in a single-response mode, the D6 audio is broadcast; and when the string-plucking source signal is F3, and is a non-single-response mode, the-d audio is broadcast.

When A1, A2, A3, A4, A5, A6 are pressed, the E channel is entered:

Broadcasting E1 audio when the string-plucking source signal is F1 and is in a single-response mode; broadcasting -E audio when the string-plucking source signal is F1 and is a non-single-response mode;

Broadcasting E2 audio when the string-plucking source signal is F2 and in a single-response mode; broadcasting -E audio when the string-plucking source signal is F2 and is a non-single-response mode;

Broadcasting E3 audio when the string-plucking source signal is F3 and in a single-response mode; broadcasting -E audio when the string-plucking source signal is F3 and is a non-single-response mode;

Broadcasting an E4 audio when the string-plucking source signal is F4, and broadcasting the E4 audio in a single-response mode; broadcasting -E audio when the string-plucking source signal is F4 and is a non-single-response mode;

Broadcasting the E5 audio when the string-plucking source signal is F5, and broadcasting the E5 audio in a single-response mode; broadcasting -E audio when the string-plucking source signal is F5 and is a non-single-response mode;

When the string-plucking source signal is F6, and is a single-response mode, the E6 audio is broadcast; and when the string-plucking source signal is F3, and is a non-single-response mode, the -E audio is broadcast.

When A1 is pressed and A3, A4, A5 are not pressed, enter the F channel, at this time:

Broadcasting F1 audio when the string-plucking source signal is F1 and is in a single-response mode; broadcasting -F audio when the string-plucking source signal is F1 and is a non-single-response mode;

When the string-plucking source signal is F2 and is a single-response mode, the F2 audio is broadcast; when the string-plucking source signal is F2 and is a non-single-response mode, the -F audio is broadcast;

When the string-plucking source signal is F3 and is a single-response mode, the F3 audio is broadcast; when the string-plucking source signal is F3 and is a non-single-response mode, the -F audio is broadcast;

When the string-plucking source signal is F4 and is a single-response mode, the F4 audio is broadcast; when the string-plucking source signal is F4 and is a non-single-response mode, the -F audio is broadcast;

When the string-plucking source signal is F5, and is a single-response mode, the F5 audio is broadcast; when the string-plucking source signal is F5, and is a non-single-response mode, the -F audio is broadcast;

When the string-plucking source signal is F6, and is in a single-response mode, the F6 audio is broadcast; and when the string-plucking source signal is F3, and is a non-single-response mode, the -F audio is broadcast.

When all strings are not pressed, the I channel is entered, and at this time:

Broadcasting I1 audio when the string-plucking source signal is F1 and in a single-response mode; broadcasting -I audio when the string-plucking source signal is F1 and is a non-single-response mode;

When the string-plucking source signal is F2 and is in a single-response mode, the I2 audio is broadcast; when the string-plucking source signal is F2 and is a non-single-response mode, the -I audio is broadcast;

Broadcasting the I3 audio when the string-plucking source signal is F3, and broadcasting the I3 audio in a single-response mode; broadcasting -I audio when the string-plucking source signal is F3 and is a non-single-response mode;

Broadcasting I4 audio when the string-plucking source signal is F4 and in a single-response mode; broadcasting -I audio when the string-plucking source signal is F4 and is a non-single-response mode;

Broadcasting the I5 audio when the string-plucking source signal is F5, and broadcasting the I5 audio in a single-response mode; broadcasting -I audio when the string-plucking source signal is F5 and is a non-single-response mode;

When the string-plucking source signal is F6, and is in a single-response mode, the I6 audio is broadcast; and when the string-plucking source signal is F3, and is a non-single-response mode, the -I audio is broadcast.

When the entering a-b mode is selected, the triggering conditions for entering the A channel and the B channel and the C channel and the D channel and the I channel are the same as the a-a mode, and meanwhile, the control module determines whether the pressing string combination is A1 pressing and A3, A4, A5 are not pressed, or is A1, A2, A3, A4, A5, A6 are pressed into the G channel or the H channel, and the control module matches the corresponding audio file by determining that the dialing source signal is F1 or/and F2 or/and F3 or/and F4 or/and F5 or/and F6, and then the audio file is played in a set form;

Specifically,

The triggering conditions for entering the A channel and the B channel and the C channel and the D channel and the I channel are the same as the a-a mode;

When A1 is pressed and A3, A 4, and A5 are not pressed, the G channel is entered, and at this time:

Broadcasting G1 audio when the string-plucking source signal is F1 and is in a single-sound mode; broadcasting -G audio when the string-plucking source signal is F1 and is a non-single-response mode;

Broadcasting G2 audio when the string-plucking source signal is F2 and in a single-response mode; broadcasting -G audio when the string-plucking source signal is F2 and is a non-single-response mode;

When the string-plucking source signal is F3 and is a single-response mode, the G3 audio is broadcast; when the string-plucking source signal is F3 and is a non-single-response mode, the -G audio is broadcast;

Broadcasting the G4 audio when the string-plucking source signal is F4, and broadcasting the G4 audio in a single-response mode; broadcasting -G audio when the string-plucking source signal is F4 and is a non-single-response mode;

Broadcasting G5 audio when the string-plucking source signal is F5 and in a single-response mode; broadcasting -G audio when the string-plucking source signal is F5 and is a non-single-response mode;

When the string-plucking source signal is F6, and is in a single-response mode, the G6 audio is broadcast; and when the string-plucking source signal is F3, and is a non-single-response mode, the-g audio is broadcast.

When A1, A2, A3, A4, A5, A6 are pressed, the H channel is entered

Broadcasting the H1 audio when the string-plucking source signal is F1, and broadcasting the HI audio in a single-response mode; broadcasting -H audio when the string-plucking source signal is F1 and is a non-single-response mode;

When the string-plucking source signal is F2 and is a single-response mode, the H2 audio is broadcast; when the string-plucking source signal is F2 and is a non-single-response mode, the -H audio is broadcast;

When the string-plucking source signal is F3 and is a single-response mode, the H3 audio is broadcast; when the string-plucking source signal is F3 and is a non-single-response mode, the -H audio is broadcast;

When the string-plucking source signal is F4, and in a single-response mode, broadcasting the H4 audio; when the string-plucking source signal is F4, and is a non-single-response mode, broadcasting -H audio;

Broadcasting the H5 audio when the string-plucking source signal is F5, and broadcasting the H5 audio in a single-sound mode; broadcasting -H audio when the string-plucking source signal is F5 and is a non-single-response mode;

When the string-plucking source signal is F6, and is in a single-response mode, the H6 audio is broadcast; and when the string-plucking source signal is F3, and is a non-single-response mode, the -H audio is broadcast.

When entering the b-a mode, the control module determines whether the pressing string combination is A2, A4, A5 is pressed and A1, A3 are not pressed,

or A2, A3, A4 are pressed and A1, A5 are not pressed, and A1, A3, A6 are pressed and A2, A3, A4 are pressed and A2, A3, A4 are not pressed, or whether A1, A2, A3, A4, A5, A6 are pressed, or whether A1 is A1, A2, A3 are pressed down and A4 and A5 are not pressed, or A2, A3, and A4 are pressed, and A1, A5 are not pressed, or A4, A5 are pressed and A1, A2, A3 are not pressed, or A1, A5 and A6 are pressed and A2, A3, A4 are not pressed, or A1, A2, A3, A4, A5, and A6 are all pressed, or A1, A2, and A3 are pressed, and A4 and A5 are not pressed, or all strings are not pressed, and enter A channel or B channel or C channel or D channel or E channel or F channel or I channel according to the conditions met by the pressing string combination judged by the control module, and the control module matches the corresponding audio file by judging that the string-string-plucking source signal is F1 or/and F2 or/and F3 or/and F4 or/and F5 or/and F6, and then the audio file is played in a set form, and the specific program flow is deduced according to the specific description of the a-a mode or/and the b-a mode;

When entering the b-b mode, the triggering conditions for entering the A channel and the B channel and the C channel and the D channel and the I channel are the same as the b-a mode, and meanwhile, the control module determines whether the combination of pressed strings is A1 A2 and A3 are pressed and A4 and A5 are not pressed, or whether A1, A2, A3, A4, A5, A6 are pressed to enter the G channel or H channel. The control module matches the corresponding audio file by judging whether the string-string-plucking source signal is F1 or/and F2 or/and F3 or/and F4 or/and F5 or/and F6, and then the audio file is played in a set form, and the specific program flow is deduced by analogy according to the specific description of the a-a mode or/and the b-a mode, and so on.

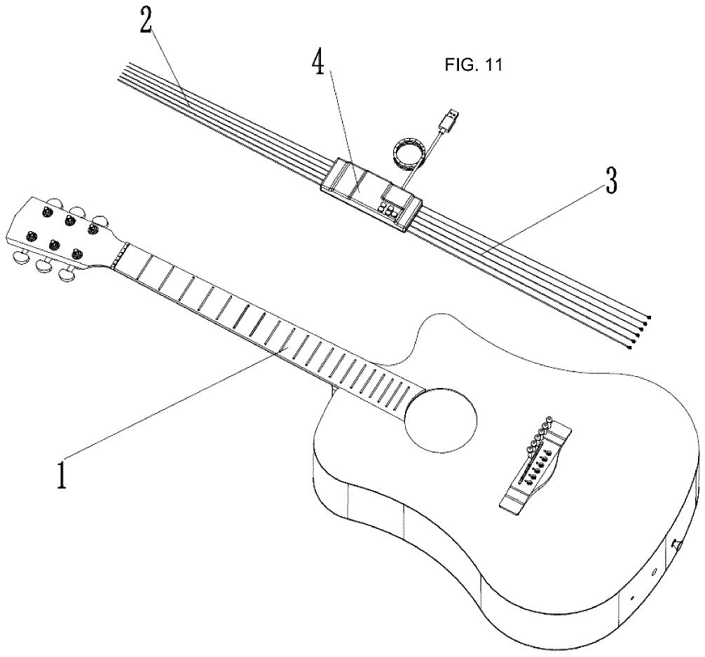

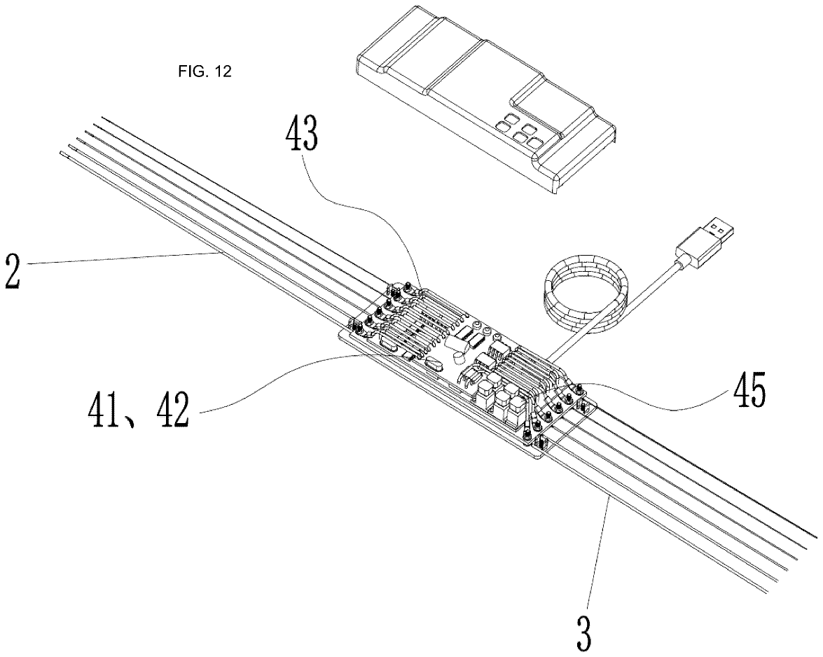

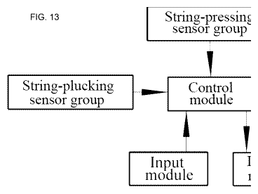

As shown in FIG. 11, FIG. 12, FIG. 13, FIG. 14, FIG. 15, FIG. 13, FIG. 17, FIG. 18, FIG. 19, FIG. 20, and FIG. 21, the control module matches the working method of the audio file according to the playing information (taking the guitar program as an example, and the audio playback module has only one audio playback channel, where the string code in the program is described: A1, B1, C1, D1 and E1 respectively represent different fret positions of upper 1 strings, A2, B2, C2, D2 and E2 respectively represent different fret positions of upper 2 strings, A3, B3, C3, D3 and E3 respectively represent different fret positions of upper 3 strings, A4, B4, C4, D4 and E4 respectively represent different fret positions of upper 4 strings, A5, B5, C5, D5 and E5 respectively represent different fret positions of upper 5 strings, A6, B6, C6, D6, and E6 respectively represent different fret positions of upper 6 strings, F1, F2, F3, F4, F5,and F6 respectively represent a lower 1 string, a lower 2 string, a lower 3 string, a lower 4 string, a lower 5 string, and a lower 6 string; The chord channel in the program indicates that the I channel represents Open chord, the A channel represents a C chord, the B channel represents an AM chord, the C channel represents an EM chord, the D channel represents a G chord, the E channel represents an F chord, the F channel represents a DM chord, the G channel represents a D chord, the H channel represents a BM chord, the J channel represents a D7 chord, the K channel represents an E chord, the L channel represents A chord, the M channel represents a G7 chord, and the N channel represents FMAJ7 chord; Audio play description in the procedure: -A represents a C chord strum, and -B represents an AM chord strum. And so on; A1, A2, A3, A4, A5, A6 represent C chord 1 chord, C chord 2 chord, C chord 3 chord, C chord 4 chord, C chord 5 chord, C chord 6 chord, B1, B2, B3, B4, B5, B6 respectively represent AM chord 1 chord, AM chord 2 chord, AM chord 3 chord, AM chord 4 chord, AM chord 5 chord, AM chord 6 chord. and soon on):

Selecting to enter an a mode or a b mode or a c mode through an input module;

When selecting to enter mode a, the control module determines whether the combination of pressed strings is A2,A4, A5 pressed and A6 not pressed and D2 pressed, or whether A3, A4, B2 pressed and A5, A6 not pressed and D4 pressed, or whether A4 or A5 is pressed and A2 or B3 is not pressed, or whether A5 or A6 is pressed and A3 is not pressed and A1 is pressed, or whether A1, A2, A3, A4, A5, A6 is pressed and one of E1, E2, E3, E4, E5, E6 is pressed, or whether A1, A2, A3, B1 are pressed and A4, A5 are not pressed, or whether A1, A2, A3 are pressed and A4, A5 are not pressed, or all strings are not pressed, or whether A1, A2,A3, B2 are pressed, or whether A4, A5, B3 are pressed and A1 is not pressed, or whether A2, A3, A4 are pressed and A5, A6 are not pressed, according to the conditions determined by the control module for the combination of pressed strings, enter the A channel, O channel, B channel, N channel, C channel, D channel, M channel, E channel, H channel, F channel, G channel, I channel, J channel, K channel, or L channel. The control module matches the corresponding audio file by determining that the plucking source signal is F1 or/and F2 or/and F3 or/and F4 or/and F5 or/and F6, and then plays the audio file using the set format;

Specifically,

When entering the a mode, the control module determines that the string combination is pressed:

When A2, A4, A5 are pressed and A6 is not pressed, and D2 is not pressed, the A channel is entered

Broadcast A1 audio when the string-plucking source signal is F1 and a single-response mode; When the string-plucking source signal is F1 and is a non-single-response mode, broadcast-A audio;

Broadcast A2 audio when the string-plucking source signal is F2 and a single-response mode; When the string-plucking source signal is F2 and is a non-single-response mode, broadcast-A audio;

Broadcasting the A3 audio when the string-plucking source signal is F3 and in a single-response mode; Broadcasting-A audio when the string-plucking source signal is F3 and is a non-single-response mode;

Broadcasting the A4 audio when the string-plucking source signal is F4 and in a single-response mode; Broadcasting-A audio when the string-plucking source signal is F4 and is a non-single-response mode;

When the string-plucking source signal is F5, and is in a single-response mode, the A5 audio is broadcast; When the string-plucking source signal is F5, and is a non-single-response mode, the -A audio is broadcast;

When the string-plucking source signal is F6, and is a single-response mode, the A6 audio is broadcast; And when the string-plucking source signal is F3, and is a non-single-response mode, the -A audio is broadcast.

When A2, A4, A5 are pressed and A6 is not pressed, and D2 is pressed, the O channel is entered, at which point:

Broadcasting O1 audio when the string-plucking source signal is F1 and in a single-response mode; Broadcasting -O audio when the string-plucking source signal is F1 and is a non-single-response mode;

Broadcasting O2 audio when the string-plucking source signal is F2 and in a single-response mode; Broadcasting -O audio when the string-plucking source signal is F2 and is a non-single-response mode;

When the string-plucking source signal is F3 and is in a single-response mode, the O3 audio is broadcast; When the string-plucking source signal is F3 and is a non-single-response mode, the -O audio is broadcast;

Broadcasting O4 audio when the string-plucking source signal is F4 and in a single-response mode; Broadcasting -O audio when the string-plucking source signal is F4 and is a non-single-response mode;

Broadcasting O5 audio when the string-plucking source signal is F5 and in a single-response mode; Broadcasting -O audio when the string-plucking source signal is F5 and is a non-single-response mode;

When the string-plucking source signal is F6 and is a single-response mode, the O6 audio is broadcast; And when the string-plucking source signal is F3 and is a non-single-response mode, the -O audio is broadcast.

When A3, A4, B2 are pressed and A5 and A6 are not pressed, and D4 is not pressed, B channels are entered, at this time:

Broadcasting B1 audio when the string-plucking source signal is F1 and in a single-response mode; Broadcasting -B audio when the string-plucking source signal is F1 and is a non-single-response mode;

Broadcast a B2 audio when the string-plucking source signal is F2 and a single-response mode; When the string-plucking source signal is F2 and is a non-single-response mode, broadcast -B audio;

Broadcasting B3 audio when the string-plucking source signal is F3 and in a single-response mode; Broadcasting -B audio when the string-plucking source signal is F3 and is a non-single-response mode;

Broadcasting B4 audio when the string-plucking source signal is F4 and in a single-response mode; Broadcasting -B audio when the string-string-plucking source signal is F4 and is a non-single-response mode;

Broadcasting the B5 audio in a single-response mode when the string-plucking source signal is F5, and broadcasting the B5 audio in a single-response mode; And broadcasting the -B audio in a non-single-response mode;

When the string-plucking source signal is F6, and is a single-response mode, the B6 audio is broadcast; And when the string-plucking source signal is F3, and is a non-single-response mode, the -B audio is broadcast.

When A3, A4, B2 are pressed and A5, A6 are not pressed, and D4 is pressed, the N channel is entered, at this time:

Broadcasting N1 audio when the string-plucking source signal is F1 and in a single-response mode; Broadcasting -N audio when the string-plucking source signal is F1 and is a non-single-response mode;

Broadcasting N2 audio when the string-plucking source signal is F2 and in a single-response mode; Broadcasting -N audio when the string-plucking source signal is F2 and is a non-single-response mode;

Broadcasting N3 audio when the string-plucking source signal is F3 and in a single-response mode; Broadcasting -N audio when the string-plucking source signal is F3 and is a non-single-response mode;

Broadcasting N4 audio when the string-plucking source signal is F4 and in a single-response mode; Broadcasting -N audio when the string-plucking source signal is F4 and is a non-single-response mode;

Broadcasting the N5 audio when the string-plucking source signal is F5, and broadcasting the N5 audio in a single-response mode; Broadcasting -N audio when the string-plucking source signal is F5 and is a non-single-response mode;

When the string-plucking source signal is F6, and is in a single-response mode, the N6 audio is broadcast; And when the string-plucking source signal is F3, and is a non-single-response mode, the -N audio is broadcast.

When A4, A5 are pressed and A2 and B3 are not pressed, the C channel is entered, and at this time:

Broadcasting the C1 audio when the string-plucking source signal is F1, and broadcasting the C1 audio in a single-response mode; Broadcasting -C audio when the string-plucking source signal is F1 and is a non-single-response mode;

Broadcasting the C2 audio when the string-plucking source signal is F2, and broadcasting the C2 audio in a single-response mode; Broadcasting -C audio when the string-plucking source signal is F2 and is a non-single-response mode;

Broadcasting C3 audio when the string-plucking source signal is F3 and in a single-response mode; Broadcasting -C audio when the string-plucking source signal is F3 and is a non-single-response mode;

Broadcasting C4 audio when the string-plucking source signal is F4 and in a single-response mode; Broadcasting -C audio when the string-plucking source signal is F4 and is a non-single-response mode;

Broadcasting C5 audio when the string-plucking source signal is F5, and broadcasting C5 audio in a single-sound mode; Broadcasting -C audio when the string-plucking source signal is F5 and is in a non-single-response mode;

When the string-plucking source signal is F6, and is in a single-response mode, the C6 audio is broadcast; And when the string-plucking source signal is F3, and is a non-single-response mode, the -C audio is broadcast.

When A5, A6 are pressed and A3 is not pressed, and A1 is not pressed, entering the D channel, at this time:

Broadcasting the audio of D1 when the string-plucking source signal is F1 and in a single-response mode; Broadcasting -D audio when the string-plucking source signal is F1 and is a non-single-response mode;

Broadcasting D2 audio when the string-plucking source signal is F2 and in a single-response mode; Broadcasting -D audio when the string-plucking source signal is F2 and is a non-single-response mode;

Broadcasting D3 audio when the string-plucking source signal is F3 and in a single-response mode; Broadcasting -D audio when the string-plucking source signal is F3 and is a non-single-response mode;

Broadcasting D4 audio when the string-plucking source signal is F4 and in a single-response mode; Broadcasting -D audio when the string-plucking source signal is F4 and is a non-single-response mode;

Broadcasting D5 audio when the string-plucking source signal is F5 and in a single-response mode; Broadcasting -D audio when the string-plucking source signal is F5 and is a non-single-response mode;

When the string-plucking source signal is F6, and is in a single-response mode, the D6 audio is broadcast; And when the string-plucking source signal is F3, and is a non-single-response mode, the -D audio is broadcast.

When A5, A6 are pressed and A3 is not pressed, and A1 is pressed, the M channel is entered, at this time:

Broadcasting M1 audio when the string-plucking source signal is F1 and in a single-response mode; Broadcasting -M audio when the string-plucking source signal is F1 and is a non-single-response mode;

Broadcast M2 audio when the string-plucking source signal is F2 and a single-response mode; When the string-plucking source signal is F2 and is a non-single-response mode, broadcast-M audio;

Broadcasting M3 audio when the string-plucking source signal is F3 and in a single-response mode; Broadcasting -M audio when the string-plucking source signal is F3 and is a non-single-response mode;

Broadcasting M4 audio when the string-plucking source signal is F4 and in a single-response mode; Broadcasting -M audio when the string-plucking source signal is F4 and is a non-single-response mode;

Broadcasting the M5 audio when the string-plucking source signal is F5, and broadcasting the M5 audio in a single-response mode; Broadcasting -M audio when the string-plucking source signal is F5 and is a non-single-response mode;

When the string-plucking source signal is F6, and is in a single-response mode, the M6 audio is broadcast; And when the string-plucking source signal is F3, and is a non-single-response mode, the -M audio is broadcast.

When A1, A2, A3, A4, A5, A6 are pressed and E1, E2, E3, E4, E5, and E6 are not pressed, the E channel is entered

Broadcasting E1 audio when the string-plucking source signal is F1 and is in a single-response mode; Broadcasting -E audio when the string-plucking source signal is F1 and is a non-single-response mode;

Broadcasting E2 audio when the string-plucking source signal is F2 and in a single-response mode; Broadcasting -E audio when the string-plucking source signal is F2 and is a non-single-response mode;

Broadcasting E3 audio when the string-plucking source signal is F3 and in a single-response mode; Broadcasting -E audio when the string-plucking source signal is F3 and is a non-single-response mode;

Broadcasting an E4 audio when the string-plucking source signal is F4, and broadcasting the E4 audio in a single-response mode; Broadcasting -E audio when the string-plucking source signal is F4 and is a non-single-response mode;

Broadcasting the E5 audio when the string-plucking source signal is F5, and broadcasting the E5 audio in a single-response mode; Broadcasting -E audio when the string-plucking source signal is F5 and is a non-single-response mode;

When the string-plucking source signal is F6, and is a single-response mode, the E6 audio is broadcast; And when the string-plucking source signal is F3, and is a non-single-response mode, the -E audio is broadcast.

When A1, A2, A3, A4, A5, A6 are pressed and one of E1, E2, E3, E4, E5, E6 is pressed, the H channel is entered

Broadcasting the H1 audio when the string-plucking source signal is F1, and broadcasting the H1 audio in a single-response mode; Broadcasting -H audio when the string-plucking source signal is F1 and is a non-single-response mode;

When the string-plucking source signal is F2 and is a single-response mode, the H2 audio is broadcast; When the string-plucking source signal is F2 and is a non-single-response mode, the-H audio is broadcast;

When the string-plucking source signal is F3 and is a single-response mode, the H3 audio is broadcast; When the string-plucking source signal is F3 and is a non-single-response mode, the-H audio is broadcast;

When the string-plucking source signal is F4, and in a single-response mode, broadcasting the H4 audio; When the string-plucking source signal is F4, and is a non-single-response mode, broadcasting-H audio;

Broadcasting the H5 audio when the string-plucking source signal is F5, and broadcasting the H5 audio in a single-sound mode; Broadcasting -H audio when the string-plucking source signal is F5 and is a non-single-response mode;

When the string-plucking source signal is F6, and is in a single-response mode, the H6 audio is broadcast; And when the string-plucking source signal is F3, and is a non-single-response mode, the -H audio is broadcast.

When A1, A2, A3, B1 are pressed and A4 and A5 are not pressed, enter the F channel, at this time:

Broadcasting F1 audio when the string-plucking source signal is F1 and is in a single-response mode; Broadcasting -F audio when the string-plucking source signal is F1 and is a non-single-response mode;

When the string-plucking source signal is F2 and is a single-response mode, the F2 audio is broadcast; When the string-plucking source signal is F2 and is a non-single-response mode, the -F audio is broadcast;

When the string-plucking source signal is F3 and is a single-response mode, the F3 audio is broadcast; When the string-plucking source signal is F3 and is a non-single-response mode, the -F audio is broadcast;

When the string-plucking source signal is F4 and is a single-response mode, the F4 audio is broadcast; When the string-plucking source signal is F4 and is a non-single-response mode, the -F audio is broadcast;

When the string-plucking source signal is F5, and is a single-response mode, the F5 audio is broadcast; When the string-plucking source signal is F5, and is a non-single-response mode, the -F audio is broadcast;

When the string-plucking source signal is F6, and is in a single-response mode, the F6 audio is broadcast; And when the string-plucking source signal is F3, and is a non-single-response mode, the -F audio is broadcast.

When A1, A2, A3 are pressed and A4 and A5 are not pressed, the G channel is entered, and at this time:

Broadcasting G1 audio when the string-plucking source signal is F1 and is in a single-sound mode; Broadcasting -G audio when the string-plucking source signal is F1 and is a non-single-response mode;

Broadcasting G2 audio when the string-plucking source signal is F2 and in a single-response mode; Broadcasting -G audio when the string-plucking source signal is F2 and is a non-single-response mode;

When the string-plucking source signal is F3 and is a single-response mode, the G3 audio is broadcast; When the string-plucking source signal is F3 and is a non-single-response mode, the -G audio is broadcast;

Broadcasting the G4 audio when the string-plucking source signal is F4, and broadcasting the G4 audio in a single-response mode; Broadcasting -G audio when the string-plucking source signal is F4 and is a non-single-response mode;

Broadcasting G5 audio when the string-plucking source signal is F5 and in a single-response mode; Broadcasting -G audio when the string-plucking source signal is F5 and is a non-single-response mode;

When the string-plucking source signal is F6, and is in a single-response mode, the G6 audio is broadcast; And when the string-plucking source signal is F3, and is a non-single-response mode, the -G audio is broadcast.

When all strings are not pressed, the I channel is entered, and at this time:

Broadcasting I 1 audio when the string-plucking source signal is F 1 and in a single-response mode; Broadcasting -I audio when the string-plucking source signal is F1 and is a non-single-response mode;

When the string-plucking source signal is F2 and is in a single-response mode, the I2 audio is broadcast; When the string-plucking source signal is F2 and is a non-single-response mode, the -I audio is broadcast;

Broadcasting the I3 audio when the string-plucking source signal is F3, and broadcasting the I3 audio in a single-response mode; Broadcasting -I audio when the string-plucking source signal is F3 and is a non-single-response mode;

Broadcasting I4 audio when the string-plucking source signal is F4 and in a single-response mode; Broadcasting -I audio when the string-plucking source signal is F 4 and is a non-single-response mode;

Broadcasting the I5 audio when the string-plucking source signal is F5, and broadcasting the I5 audio in a single-response mode; Broadcasting -I audio when the string-plucking source signal is F5 and is a non-single-response mode;

When the string-plucking source signal is F6, and is in a single-response mode, the I6 audio is broadcast; And when the string-plucking source signal is F3, and is a non-single-response mode, the -I audio is broadcast.

When A1, A2, A3 and B2 are pressed, the J channel is entered, and at this time:

Broadcasting the J1 audio when the string-plucking source signal is F1 and in a single-response mode; Broadcasting -J audio when the string-plucking source signal is F1 and is a non-single-response mode;

Broadcasting the J2 audio when the string-plucking source signal is F2, and broadcasting the J2 audio in a single-response mode; Broadcasting -J audio when the string-plucking source signal is F2 and is a non-single-response mode;

Broadcasting the J3 audio when the string-plucking source signal is F3 and in a single-response mode; Broadcasting -J audio when the string-plucking source signal is F3 and is a non-single-response mode;

Broadcasting J4 audio when the string-plucking source signal is F4 and in a single-response mode; Broadcasting -J audio when the string-plucking source signal is F4 and is a non-single-response mode;

Broadcasting J5 audio when the string-plucking source signal is F5 and in a single-response mode; Broadcasting -J audio when the string-plucking source signal is F5 and is a non-single-response mode;

When the string-plucking source signal is F6, and is in a single-response mode, the J6 audio is broadcast; And when the string-plucking source signal is F3, and is a non-single-response mode, the -J audio is broadcast.

When A4, A5, B3 are pressed and A1 is not pressed, the K channel is entered, and at this time:

Broadcasting K1 audio when the string-plucking source signal is F1 and in a single-response mode; Broadcasting -K audio when the string-plucking source signal is F1 and is a non-single-response mode;

Broadcast K2 audio when the string-plucking source signal is F2 and a single-response mode; When the string-plucking source signal is F2 and is a non-single-response mode, broadcast -K audio;

When the string-plucking source signal is F3 and is a single-response mode, the K3 audio is broadcast; When the string-plucking source signal is F3 and is a non-single-response mode, the -K audio is broadcast;

Broadcasting the K4 audio when the string-plucking source signal is F4, and broadcasting the K4 audio in a single-response mode; Broadcasting -K audio when the string-plucking source signal is F4 and is a non-single-response mode;

When the string-plucking source signal is F5, and is a single-response mode, the K5 audio is broadcast; When the string-plucking source signal is F5, and is a non-single-response mode, the -K audio is broadcast;

When the string-plucking source signal is F6, and is in a single-response mode, the K6 audio is broadcast; And when the string-plucking source signal is F3, and is a non-single-response mode, the -K audio is broadcast.

When A2, A3, A4 are pressed and A5 and A6 are not pressed, the L channel is entered.

Broadcasting the L1 audio when the string-plucking source signal is F1, and broadcasting the L1 audio in a single-response mode; Broadcasting -L audio when the string-plucking source signal is F1 and is a non-single-response mode;

Broadcasting the L2 audio when the string-plucking source signal is F2, and broadcasting the L2 audio in a single-response mode; Broadcasting -L audio when the string-plucking source signal is F2 and is a non-single-response mode;

Broadcasting L3 audio when the string-plucking source signal is F3 and in a single-response mode; Broadcasting -L audio when the string-plucking source signal is F3 and is a non-single-response mode;

Broadcasting the L4 audio in a single-response mode when the string-plucking source signal is F4, and broadcasting the L4 audio in a single-response mode; And broadcasting -L audio in a non-single-response mode;

Broadcasting the L5 audio in a single-response mode when the string-plucking source signal is F5, and broadcasting the L5 audio in a single-response mode; And broadcasting -L audio in a non-single-response mode;

When the string-plucking source signal is F6, and is in a single-response mode, the L6 audio is broadcast; And when the string-plucking source signal is F3, and is a non-single-response mode, the -L audio is broadcast.

When selecting to enter b mode, the control module determines whether the combination of pressed strings is A2,A4, A5 pressed and whether other strings are not pressed, and whether D2 is pressed, or whether A2, A3, A4 are pressed and others are not pressed, and whether D4 is pressed, or whether A4, A5 are pressed and others are not pressed, or whether A1, A5, A6 are pressed and others are not pressed, and whether A1 is pressed, or whether it is pressed by A1, A2, A3, A4, A5, A6 and whether it is pressed by one of E1, E2, E3, E4, E5, E6, or whether A1, A2, A3, B1 are pressed and others are not pressed, or whether A1, A2, A3 are pressed and others are not pressed, or all the strings have not been pressed, or whether it is A1, A2, A3, B2 pressed, or whether A4, A5, B3 are pressed and others are not pressed, or whether A2, A3, A4 are pressed and others are not pressed, according to the conditions determined by the control module for the combination of pressed strings, enter the A channel, O channel, B channel, N channel, C channel, D channel, M channel, E channel, H channel, F channel, G channel, I channel, J channel, K channel, or L channel. The control module matches the corresponding audio file by determining that the plucking source signal is F1 or/and F2 or/and F3 or/and F4 or/and F5 or/and F6, and then plays the audio file in the set form. The specific program flow is based on the specific instructions of mode a, and so on;

When the c mode is selected, the control module determines whether the plucking source signal is F1, or/and F2, or/and F3, or/and F4, or/and F5, or/and F6, while simultaneously checking the following conditions to match and play the corresponding audio file: whether no switch is pressed among A1-E1, or whether A1 and B1 in A1-E1 are pressed, or whether A1 and C1 in A1-E1 are pressed, or whether A1 and D1 in A1-E1 are pressed, or whether A1 and E1 in A1-E1 are pressed, or whether no switch is pressed among A2-E2, or whether A2 and B2 in A2-E2 are pressed, or whether A2 and C2 in A2-E2 are pressed, or whether A2 and D2 in A2-E2 are pressed, or whether A2 and E2 in A2-E2 are pressed, or whether no switch is pressed among A3-E3, or whether A3 and B3 in A3-E3 are pressed, or whether A3 and C3 in A3-E3 are pressed, or whether A3 and D3 in A3-E3 are pressed, or whether A3 and E3 in A3-E3 are pressed, or whether no switch is pressed among A4-E4, or whether A4 and B4 in A4-E4 are pressed, or whether A4 and C4 in A4-E4 are pressed, or whether A4 and D4 in A4-E4 are pressed, or whether A4 and E4 in A4-E4 are pressed, or whether no switch is pressed among A5-E5, or whether A5 and B5 in A5-E5 are pressed, or whether A5 and C5 in A5-E5 are pressed, or whether A5 and D5 in A5-E5 are pressed, or whether A5 and E5 in A5-E5 are pressed, or whether no switch is pressed among A6-E6, or whether A6 and B6 in A6-E6 are pressed, or whether A6 and C6 in A6-E6 are pressed, or whether A6 and D6 in A6-E6 are pressed, or whether A6 and E6 in A6-E6 are pressed. Based on these conditions, the corresponding audio file is matched and played.

Specifically,

When F1 is pressed, and A1-E1 does not have a string pressed, broadcast A1 voice;

When F1 is pressed and A1 and B1 in A1-E1 are pressed, B1 is broadcast;

When F1 is pressed and A1 and C1 in A1-E1 are pressed, the C1 voice is broadcast;

When F1 is pressed and A1 and D1 in A1-E1 are pressed, the voice of D1 is broadcast;

When F1 is pressed and A1 and E1 in A1-E1 are pressed, the E1 voice is broadcast;

When F1 is pressed and A1 and F1 in A1-E1 are pressed down, the F1 voice is broadcasted;

When F2 is pressed, and A2-E2 does not have a string pressed, the A2-E2 broadcasts A2 voice;

When F2 is pressed and A2 and B2 in A2-E2 are pressed, B2 voice is broadcast;

When F2 is pressed and A2 and C2 in A2-E2 are pressed, the C2 voice is broadcast;

When F2 is pressed and A2 and D2 in A2-E2 are pressed, the voice of D2 is broadcast;

When F2 is pressed and A2 and E2 in A2-E2 are pressed, the E2 voice is broadcast;

When F2 is pressed and A2 and F2 in A2-E2 are pressed, the F2 voice is broadcast;

When F3 is pressed, and A3-E3 does not have a string pressed, broadcast A3 voice;

When F3 is pressed and A3 and B3 in A3-E3 are pressed, B3 voice is broadcast;

When F3 is pressed and A3 and C3 in A3-E3 are pressed, the C3 voice is broadcast;

When F3 is pressed and A3 and D3 in A3-E3 are pressed, the voice of D3 is broadcast;

When F3 is pressed and A3 and E3 in A3-E3 are pressed, E3 voice is broadcast;

When F3 is pressed and A3 and F3 in A3-E3 are pressed down, F3 voice is broadcasted;

When F4 is pressed, and A4 -E4 does not have a string pressed, the A4-E4 broadcasts A4 voice;

When F4 is pressed, and A4 and B4 in A4-E4 are pressed, broadcast B4 voice;

When F4 is pressed and A4 and C4 in A4-E4 are pressed, the C4 voice is broadcast;

When F4 is pressed and A4 and D4 in A4-E4 are pressed, the voice of D4 is broadcast;

When F4 is pressed and A4 and E4 in A4-E4 are pressed, E4 voice is broadcast;

When F4 is pressed and A4 and F4 in A4-E4 are pressed, the F4 voice is broadcast;

When F5 is pressed and there is no string-pressing in A5-E5, broadcasting A5 voice;

When F5 is pressed and A5 and B5 in A5-E5 are pressed, B5 voice is broadcast;

When F5 is pressed and A5 and C5 in A5-E5 are pressed, the C5 voice is broadcast;

When F5 is pressed and A5 and D5 in A5-E5 are pressed, the voice of D5 is broadcast;

When F5 is pressed and A5 and E5 in A5-E5 are pressed, E5 voice is broadcast;

When F5 is pressed and A5 and F5 in A5-E5 are pressed, the F5 voice is broadcast;

When F6 is pressed, and A6-E6 does not have a string pressed, the A6 voice is broadcast;

When F6 is pressed and A6 and B6 in A6-E6 are pressed, B6 voice is broadcast;

When F6 is pressed and A6 and C6 in A6-E6 are pressed, the C6 voice is broadcast;

When F6 is pressed and A6 and D6 in A6-E6 are pressed, the voice of D6 is broadcast;

When F6 is pressed and A6 and E6 in A6-E6 are pressed, the E6 voice is broadcast;

When F6 is pressed and A6 and F6 in A6-E6 are pressed, F6 speech is broadcast.

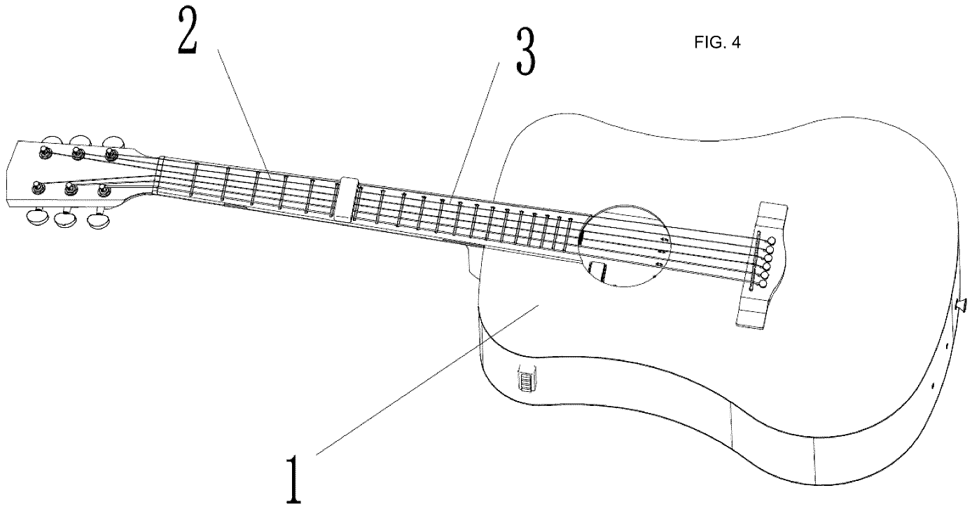

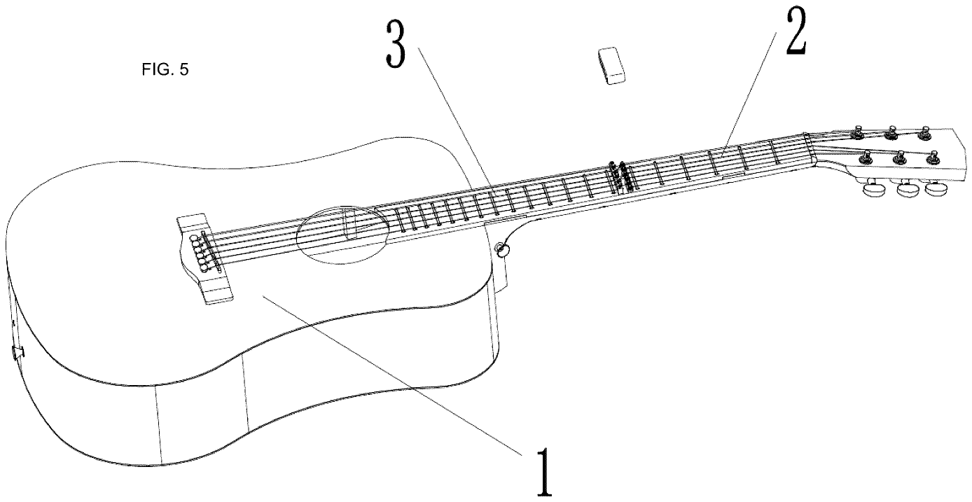

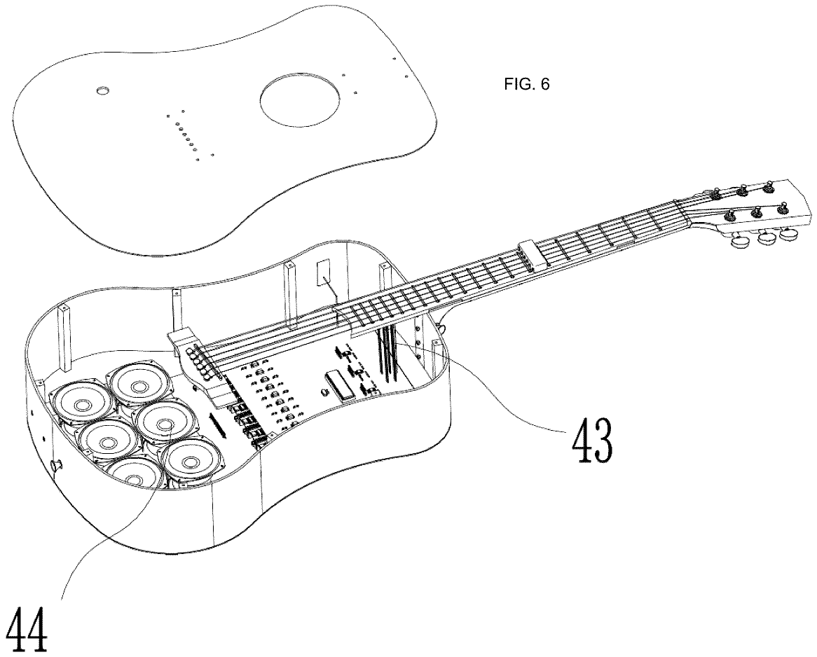

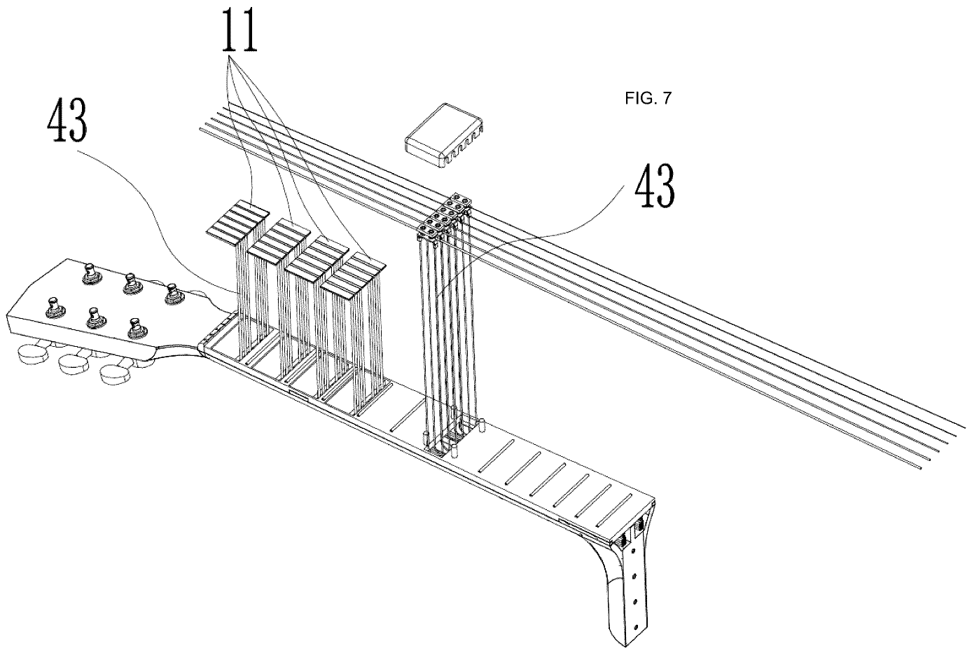

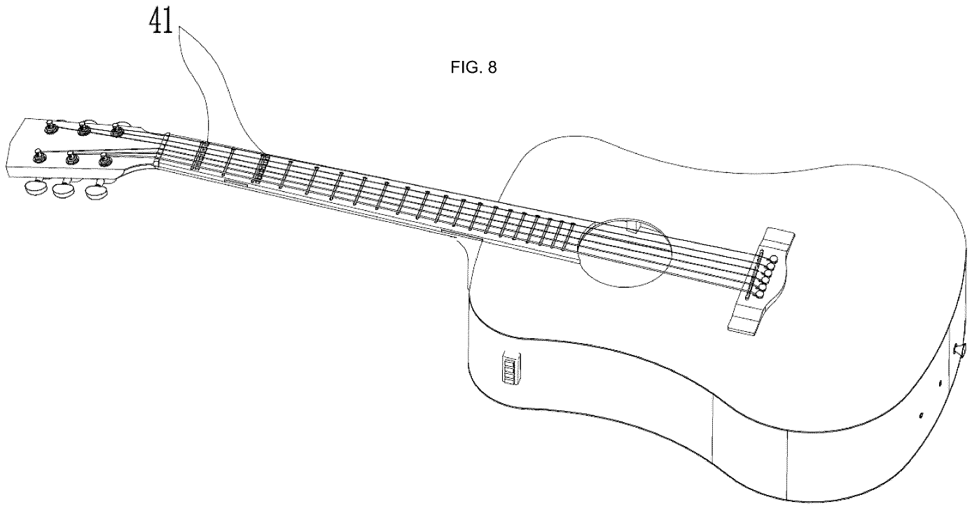

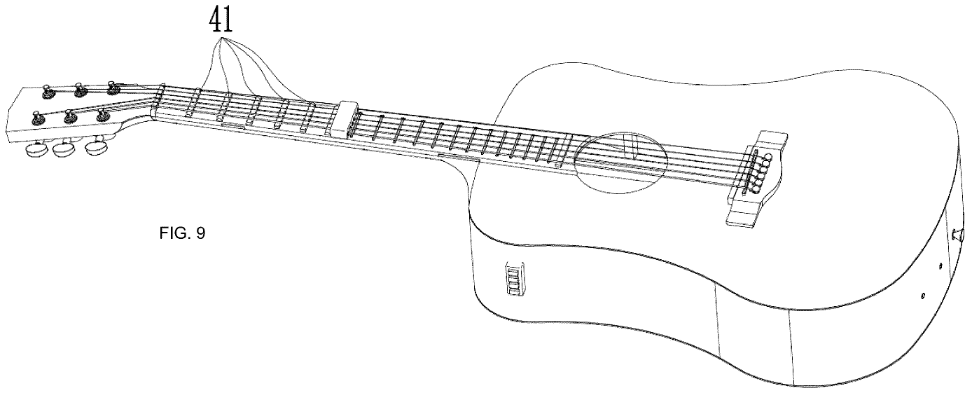

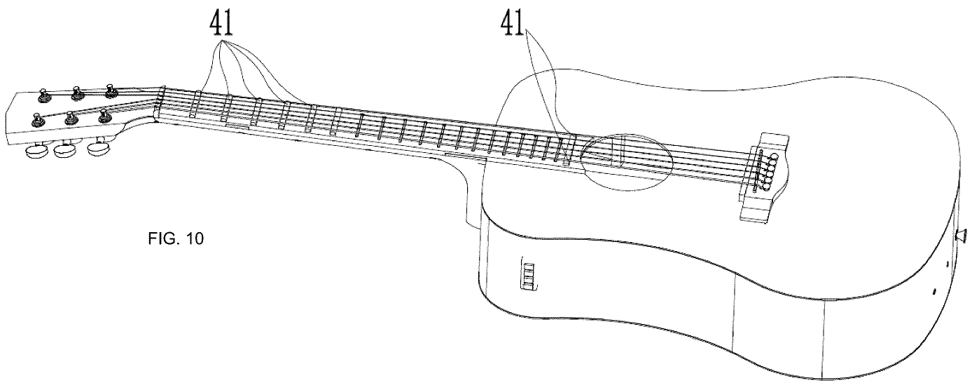

In order to specifically describe the sound production method of the intelligent error correction guitar, referring to FIG. 4, FIG. 5, FIG. 6, FIG. 7, FIG. 8, FIG. 9 and FIG. 10, when the control module, a string-pressing sensor group 41, the string-plucking sensor group 42 and the audio playback module are all disposed on the guitar body, the guitar body includes a guitar case 1, six upper strings 2, and six lower strings 3; The a string-pressing sensor group 41 includes six or thirty string-pressing sensors, and the string-plucking sensor group 42 includes six string-plucking sensors. The string-pressing sensors are designed to detect either the full-string-plucking of the corresponding upper strings 2 or the plucking at specific fret positions on these upper strings 2. Depending on the sensor type, the string-pressing sensors can be directly mounted on the fingerboard to sense string presses or integrated into the guitar body with wiring harnesses 43 connecting to the respective strings. The string-plucking sensors detect plucks on the corresponding lower strings 3. Both the string-pressing and string-plucking sensors are connected to the control module housed within the guitar body 1, which interfaces with the audio playback module 44. As shown in FIG. 6, the guitar case 1 contains six independent audio playback channels. During string-pressing, the sensors identify which upper string 2 or its specific fret position is pressed. For plucking actions, users directly strum the lower string 3 with their fingers.

Specifically, as shown in FIG. 4, FIG. 5, and FIG. 6, an intelligent error correction guitar using a touch switch to sense a string, a conductive upper string 2 and a lower string 3 are fixed on the string column, the string column is connected to the touch switch through a wire 43, the touch switch is connected to a signal input interface of the circuit chip, so that the touch range of the touch switch is enlarged to the string, and when the hand is pressed, the corresponding touch switch is triggered when the string is plucked, and the signal is input into the circuit chip; As shown in FIG. 7, another intelligent error correction guitar using a touch switch to sense a string can arrange a plurality of mutually independent iron sheets 11 below the upper string 2, the iron sheet 11 is connected to the touch switch through a wire 43, the touch switch is connected to a signal input interface of the circuit chip, and when the string is pressed, the string is in contact with the corresponding iron sheet 11, thereby triggering a corresponding touch switch; As shown in FIG. 8, the button switch is used to sense the intelligent error correction guitar of the upper string, the button switch is installed below the upper string 2, the button switch is connected to the signal input interface of the circuit chip through the wire 43, the upper string 2 is pressed to be pressed to the button switch, and the lower string 3 uses a photosensitive probe sensor or a vibration switch sensor or other touch sensors; As shown in FIG. 9 and FIG. 10, the intelligent error correction guitar using the light sensing probe to sense the strings includes: installing the light sensing probe sensor below the string, connecting the light sensing probe sensor to the signal input interface of the circuit chip through the wire 43, and pressing the string or pulling the string to trigger the sensor, wherein the touch sensor is usually integrated and installed in the guitar box.

In order to specifically describe the sound production method of the intelligent error correction guitar, as shown in FIG. 11 and FIG. 12, a guitar is used in cooperation with the auxiliary device body 4 for sound production, the guitar body comprises a guitar box body 1, six upper strings 2, and six lower strings 3, the auxiliary device body 4 comprises a control module, a string-pressing sensor group 41 and the string-plucking sensor group 42, the string-pressing sensor group 41 comprises six string-pressing sensors or thirty string-pressing sensors, and the string-plucking sensor group 42 comprises six string-plucking sensors. The string-pressing sensor is used to sense the entire string playing of the corresponding upper string 2 or the string playing at the corresponding fret position of the corresponding upper string 2, the string-plucking sensor is configured to sense playing of a corresponding lower string 3, the string-pressing sensor and the string-plucking sensor are both connected to the control module, the control module is paired with the smart terminal through wired or wireless data transmission, the smart terminal processes the received string playing information sent by the control module and plays a corresponding audio file stored in the smart terminal, and the auxiliary device 4 may be provided with an input module 45 for mode selection.

Specifically, referring to FIG. 8, FIG. 9, and FIG. 10, when the sensor of the intelligent error correction guitar using the auxiliary device body 4 is installed on the neck, referring to FIG. 4, FIG. 5, FIG. 6 and FIG. 7, when the touch sensor of the intelligent error correction guitar using the auxiliary device body 4 is integrated in the auxiliary device body 4, reference may be made to FIG. 4, FIG. 5, FIG. 6, and FIG. 7.

The intelligent error correction guitar can be set by a program in the circuit chip, and default to pressing an error by a beginner is to press the correct chord by default, so that the beginner can smoothly play the song under the condition of unskilled mastering and chord, so that the beginner cannot give up learning due to the fact that the song cannot be played, and the learning interest is stimulated. After the beginner grasps certain chord skills. Then, the program in the circuit chip is set to be switched to a mode of improving the chord pressing difficulty, and the playing is continued, and when the chord skill is completely mastered, the auxiliary function of the cancelling program reaches the traditional guitar playing level.

The above are only preferred embodiments of the present disclosure and are not intended to limit the present disclosure, and for those skilled in the art, the present disclosure may have various modifications and changes. Any modification, equivalent replacement, or improvement made within the spirit and principle of the present disclosure shall fall within the protection scope of the present disclosure.

The invention claimed is:

1: A sound production method of the intelligent error correction guitar, the intelligent error correction guitar comprises a control module, an audio playback module, a string-pressing sensor group and a string-plucking sensor group. When the intelligent error correction guitar works, the control module is used for receiving the string-pressing combination signal collected by the string-pressing sensor group and the string-plucking source signal collected by the string-plucking sensor group, when the control module receives the signal from the string-pressing sensor group, it matches it with the preset string-pressing combination in the control module; the control module receives the string-string-plucking source signal of the string-plucking sensor group at the same time, and the control module determines the corresponding audio file for playback via the audio playback module by matching the input string-pressing combination with the predefined chord configuration and analyzing the chord information.

2: The sound production method of the intelligent error correction guitar according to claim 1, further comprising an input module, wherein the input module is configured to input one or more modes by using the input module and send the mode setting to the control module, and the control module matches the mode setting while matching the string-pressing combination and the string-string-plucking source signal, and then plays the specified audio file through the audio playback module.

3: The sound production method of the intelligent error correction guitar according to claim 1 or 2, wherein the preset string-pressing combination in the control module includes a string-pressing sensor signal that must be triggered during chord playing and a string-pressing sensor signal that must not be triggered.

4: The sound production method of the intelligent error correction guitar according to claim 1 or 2, wherein the setting control module sends an audio playing instruction when receiving the touch action sensed by the string-plucking sensor.

5: The sound production method of the intelligent error correction guitar according to claim 1 or 2, wherein the setting control module sends an audio playing instruction after receiving the touch string sensed by the string-plucking sensor and performing a string loosening action.

6: The sound production method of the intelligent error correction guitar according to claim 1, wherein the string-pressing sensor senses the string-pressing operation on the entire string.

7: The sound production method of the intelligent error correction guitar according to claim 1, wherein the string-pressing sensor senses the string of the specific fret position of the string.

8: The sound production method of the intelligent error correction guitar according to claim 1, wherein the intelligent error correction guitar further comprises a display module for displaying the current state of the guitar.

9: The sound production method of the intelligent error correction guitar according to claim 1, wherein the control module, the input module and the audio playback module of the intelligent error correction guitar are all arranged on the guitar body.

10: The sound production method of the intelligent error correction guitar according to claim 9, wherein the audio playback module has six audio playback channels in one-to-one correspondence with the strings, and the control module respectively sends the designated audio files to the corresponding audio playback channels for playing according to the specific strings sensed by the received string-plucking sensors.

11: The sound production method of the intelligent error correction guitar according to claim 9, wherein the audio playback module has a audio playback channel.

12: The sound production method of the intelligent error correction guitar according to claim 1, wherein the control module of the intelligent error correction guitar is paired with the intelligent terminal through wired or wireless data transmission, and the intelligent terminal processes the received string sent by the control module and plays the corresponding audio file stored in the intelligent terminal.
